(19) United States
(12) Patent Application Publication
(10) Pub. No.: US 2021/0021871 A1
(43) Pub. Date: Jan. 21, 2021

(54) METHOD AND APPARATUS FOR PERFORMING LOW-COMPLEXITY OPERATION OF TRANSFORM KERNEL FOR VIDEO COMPRESSION

(71) Applicant: LG Electronics Inc., Seoul (KR)

(72) Inventors: Moonmo KOO, Seoul (KR); Mehdi SALEHIFAR, Seoul (KR); Seunghwan KIM, Seoul (KR); Jaehyun LIM, Seoul (KR)

(21) Appl. No.: 17/042,722

(22) PCT Filed: May 1, 2019
(86) PCT No.: PCT/KR2019/003743

§ 371 Date: Sep. 28, 2020

(30) Foreign Application Priority Data
Mar. 29, 2018 (KR) 10-2018-0036418

(51) Int. Cl. H04N 19/61; H04N 19/625; H04N 19/159; H04N 19/176

(52) U.S. Cl. CPC H04N 19/61; H04N 19/176; H04N 19/159; H04N 19/625

(57) ABSTRACT

The present disclosure provides a method for reconstructing a video signal based on low-complexity transform implementation including obtaining a transform index of a current block from the video signal, wherein the transform index corresponds to any one of a plurality of transform combinations including a combination of DST4 and/or DCT4; deriving a transform combination corresponding to the transform index, wherein the transform combination includes a horizontal transform and a vertical transform, and wherein the horizontal transform and the vertical transform correspond to at least one of the DST4 or the DCT4; performing an inverse transform in a vertical direction with respect to the current block by using the DST4; performing an inverse transform in a horizontal direction with respect to the current block by using the DCT4; and reconstructing the video signal by using the current block which the inverse transform is performed.

### TECHNICAL FIELD

The present disclosure relates to a method and apparatus for processing a video signal, and more particularly, to a technique for reducing memory use and operation complexity for Discrete Sine Transform-4 (DST4) and Discrete Cosine Transform-4 (DCT4) among transform kernels for video compression.

### BACKGROUND ART

Next-generation video content will have characteristics of a high spatial resolution, a high frame rate, and high dimensionality of scene representation. In order to process such content, technologies, such as memory storage, a memory access rate, and processing power, will be remarkably increased.

Accordingly, it is necessary to design a new coding tool for more efficiently processing next-generation video content. Particularly, it is necessary to design a more efficient transform in terms of coding efficiency and complexity when a transform is applied.

### DISCLOSURE

### Technical Problem

An object of the present disclosure is to propose an operation algorithm of low-complexity for a transform kernel for video compression.

Another object of the present disclosure is to propose a method for reducing memory use and operation complexity for Discrete Sine Transform-4 (DST4) and Discrete Cosine Transform-4 (DCT4) among transform kernels for video compression.

Another object of the present disclosure is to propose an encoder/decoder structure for reflecting a new transform design.

### Technical Solution

An aspect of the present disclosure provides a method for reducing complexity and improving coding rate through a new transform design.

An aspect of the present disclosure provides a method for performing Discrete Sine Transform-4 (DST4) and Discrete Cosine Transform-4 (DCT4) with forward DCT2.

An aspect of the present disclosure provides a method for performing DST4 and DCT4 with inverse DCT2.

An aspect of the present disclosure provides a method for applying DST4 and DCT4 to a transform configuration group to which Multiple Transform Selection (MTS) is applied.

### Advantageous Effects

According to the present disclosure, a method for performing Discrete Sine Transform-4 (DST4) and Discrete Cosine Transform-4 (DCT4) is provided with forward DCT2 or inverse DCT2, and accordingly, memory use and operation complexity may be reduced.

In addition, according to the present disclosure, DST4 and DCT4 is applied to a transform configuration group to which Multiple Transform Selection (MTS) is applied, and accordingly, more efficient coding may be performed.

As such, using a new low-complexity operation algorithm, operation complexity is reduced, and coding rate may be improved.

### DESCRIPTION OF DRAWINGS

FIG. 1 is a block diagram illustrating the configuration of an encoder for encoding a video signal according to an embodiment of the present invention.

FIG. 2 is a block diagram illustrating the configuration of a decoder for decoding a video signal according to an embodiment of the present invention.

FIG. 3 illustrates embodiments to which the disclosure may be applied, FIG. 3A is a diagram for describing a block split structure based on a quadtree (hereinafter referred to as a “QT”), FIG. 3B is a diagram for describing a block split structure based on a binary tree (hereinafter referred to as a “BT”), FIG. 3C is a diagram for describing a block split structure based on a ternary tree (hereinafter referred to as a “TT”), and FIG. 3D is a diagram for describing a block split structure based on an asymmetric tree (hereinafter referred to as an “AT”).

FIG. 4 is an embodiment to which the disclosure is applied and illustrates a schematic block diagram of a transform and quantization unit 120/130 and a dequantization and transform unit 140/150 within an encoder.

FIG. 5 is an embodiment to which the disclosure is applied and illustrates a schematic block diagram of a dequantization and transform unit 220/230 within a decoder.

FIG. 6 illustrates a table illustrating a transform configuration group to which Multiple Transform Selection (MTS) is applied as an embodiment to which the present disclosure is applied.

FIG. 7 is a flowchart illustrating an encoding process on which Multiple Transform Selection (MTS) is performed as an embodiment to which the present disclosure is applied.

FIG. 8 is a flowchart illustrating a decoding process on which Multiple Transform Selection (MTS) is performed as an embodiment to which the disclosure is applied.

FIG. 9 is a flowchart for describing a process of encoding an MTS flag and an MTS index as an embodiment to which the disclosure is applied.

FIG. 10 is a flowchart for describing a decoding process of applying a horizontal transform or vertical transform to a row or column based on an MTS flag and an MTS index as an embodiment to which the disclosure is applied.

FIG. 11 Illustrates a schematic block diagram of the inverse transform unit as an embodiment to which the present disclosure is applied.

FIG. 12 illustrates a block diagram for performing an inverse transform based on a transform related parameter as an embodiment to which the present disclosure is applied.

FIG. 13 illustrates a flowchart for performing an inverse transform based on a transform related parameter as an embodiment to which the present disclosure is applied.

FIG. 14 illustrates an encoding flowchart for performing Discrete Sine Transform-4 (DST4) and Discrete Cosine Transform-4 (DCT4) with forward DCT2 or inverse DCT2 as an embodiment to which the present disclosure is applied.

FIG. 15 illustrates a decoding flowchart for performing Discrete Sine Transform-4 (DST4) and Discrete Cosine Transform-4 (DCT4) with forward DCT2 or inverse DCT2 as an embodiment to which the present disclosure is applied.

FIG. 16 illustrates diagonal elements for a pair of a transform block size N and a shift amount S₁ in a right side when DST4 and DCT4 are performed in forward DCT2 as an embodiment to which the present disclosure is applied.

FIG. 17 illustrates sets of DCT kernel coefficients applicable to DST4 or DCT4 as an embodiment to which the present disclosure is applied.

FIG. 18 illustrates a forward DCT2 matrix generated from a set of DCT2 kernel coefficients applicable to DST4 or DCT4 as an embodiment to which the present disclosure is applied.

FIG. 19 illustrates a code implementation of an output step for DST4 as an embodiment to which the present disclosure is applied.

FIG. 20 illustrates a code implementation of an output step for DCT4 as an embodiment to which the present disclosure is applied.

FIG. 21 illustrates a configuration of a parameter set and multiplication coefficients for DST4 and DCT4 when DST4 and DCT4 are performed with forward DCT2 as an embodiment to which the present disclosure is applied.

FIG. 22 illustrates a code implementation of a pre-processing for DCT4 as an embodiment to which the present disclosure is applied.

FIG. 23 illustrates a code implementation of a post-processing for DST4 as an embodiment to which the present disclosure is applied.

FIG. 24 illustrates diagonal elements for a transform block size N and a right shift amount S₄ pair when DST4 and DCT4 are performed with inverse DCT2 as an embodiment to which the present disclosure is applied.

FIG. 25 illustrates a configuration of a parameter set and multiplication coefficients for DST4 and DCT4 when DST4 and DCT4 are performed with inverse DCT2 as an embodiment to which the present disclosure is applied.

FIG. 26 illustrates an MTS mapping for an intra prediction residual as an embodiment to which the present disclosure is applied.

FIG. 27 illustrates an MTS mapping for an inter prediction residual as an embodiment to which the present disclosure is applied.

FIG. 28 illustrates a content streaming system to which the disclosure is applied.

### BEST MODE FOR INVENTION

In an aspect, the present disclosure provides a method for reconstructing a video signal based on low-complexity transform implementation including obtaining a transform index of a current block from the video signal, wherein the transform index corresponds to any one of a plurality of transform combinations including a combination of DST4 and/or DCT4; deriving a transform combination corresponding to the transform index, wherein the transform combination includes a horizontal transform and a vertical transform, and wherein the horizontal transform and the vertical transform correspond to at least one of the DST4 or the DCT4; performing an inverse transform in a vertical direction with respect to the current block by using the DST4; performing an inverse transform in a horizontal direction with respect to the current block by using the DCT4; and reconstructing the video signal by using the current block which the inverse transform is performed.

In the present disclosure, the DST4 and/or the DCT4 are/is executed by using a forward DCT2 or an inverse DCT2.

In the present disclosure, the DST4 and/or the DCT4 apply/applies post-processing matrix M_{N} and pre-processing A_{N} to the forward DCT2 or the inverse DCT2 (herein,

$${[ {M}_{N}^{- 1} ]}_{n , k } = \{ \begin{matrix}1 / 2 cos \frac{π ( 2 n + 1 )}{4 N} , & if n = k \\ 0 , & otherwise\end{matrix} \\ n , k = 0 , 1 , … , N - 1 , \\ {[ {A}_{N}^{- 1} ]}_{n , k} = \{ \begin{matrix}\sqrt{2} , & n = k = 0 \\ 1 , & n = k or k + 1 \\ 0 , & otherwise\end{matrix} , \\ n = 1 , 2 , … , N - 1 , k = 0 , 1 , … , N - 1 , \\ herein , N represents a block size ) .$$

In the present disclosure, the inverse transform of the DST4 is applied for each column when the vertical transform is the DST4, and wherein the inverse transform of the DCT4 is applied for each row when the horizontal transform is the DCT4.

In the present disclosure, the transform combination (horizontal transform, vertical transform) includes (DST4, DST4), (DCT4, DST4), (DST4, DCT4) and (DCT4, DCT4).

In the present disclosure, when the current block is an intra predicted residual, the transform combination corresponds to transform indexes 0, 1, 2 and 3.

In the present disclosure, when the current block is an inter predicted residual, the transform combination corresponds to transform indexes 3, 2, 1 and 0.

In another aspect, the present disclosure provides, an apparatus for reconstructing a video signal based on low-complexity transform implementation including a parsing unit for obtaining a transform index of a current block from the video signal, wherein the transform index corresponds to any one of a plurality of transform combinations including a combination of DST4 and/or DCT4; a transform unit for deriving a transform combination corresponding to the transform index, performing an inverse transform in a vertical direction with respect to the current block by using the DST4, and performing an inverse transform in a horizontal direction with respect to the current block by using the DCT4, wherein the transform combination includes a horizontal transform and a vertical transform, and wherein the horizontal transform and the vertical transform correspond to at least one of the DST4 or the DCT4; and a reconstruction unit for reconstructing the video signal by using the current block which the inverse transform is performed.

### MODE FOR INVENTION

Hereinafter, a configuration and operation of an embodiment of the present invention will be described in detail with reference to the accompanying drawings, a configuration and operation of the present invention described with reference to the drawings are described as an embodiment, and the scope, a core configuration, and operation of the present invention are not limited thereto.

Further, terms used in the present invention are selected from currently widely used general terms, but in a specific case, randomly selected terms by an applicant are used. In such a case, in a detailed description of a corresponding portion, because a meaning thereof is clearly described, the terms should not be simply construed with only a name of terms used in a description of the present invention and a meaning of the corresponding term should be comprehended and construed.

Further, when there is a general term selected for describing the invention or another term having a similar meaning, terms used in the present invention may be replaced for more appropriate interpretation. For example, in each coding process, a signal, data, a sample, a picture, a frame, and a block may be appropriately replaced and construed. Further, in each coding process, partitioning, decomposition, splitting, and division may be appropriately replaced and construed.

In the present disclosure, MTS (Multiple Transform Selection, hereinafter, referred to as ‘MTS’) may mean a method for performing a transform by using at least two transform types. This may also be represented as AMT (Adaptive Multiple Transform) or EMT (Explicit Multiple Transform), and similarly, represented as mts_idx, AMT_idx, EMT_idx, tu_mts_idx, AMT_TU_idx, EMT_TU_idx, transform index or transform combination index, but the present disclosure is not limited thereto.

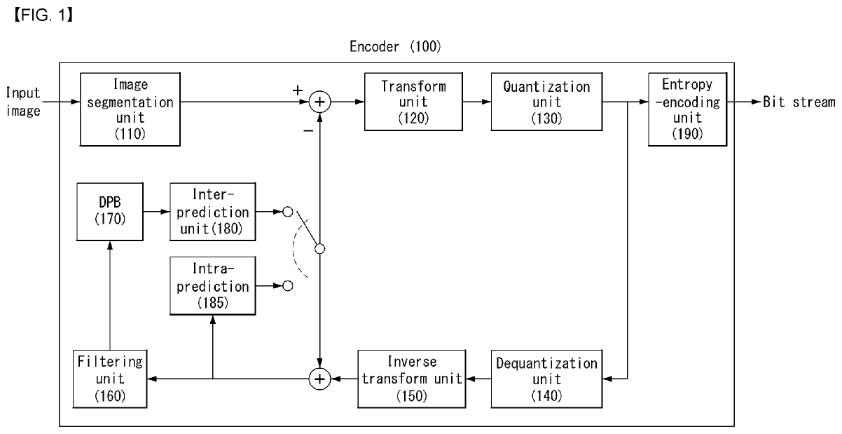

FIG. 1 shows a schematic block diagram of an encoder for encoding a video signal, in accordance with one embodiment of the present invention.

Referring to FIG. 1, the encoder 100 may include an image segmentation unit 110, a transform unit 120, a quantization unit 130, a dequantization unit 140, an inverse transform unit 150, a filtering unit 160, a decoded picture buffer (DPB) 170, an inter-prediction unit 180, an intra-predictor 185 and an entropy encoding unit 190.

The image segmentation unit 110 may segment an input image (or a picture or frame), input to the encoder 100, into one or more processing units. For example, the process unit may be a coding tree unit (CTU), a coding unit (CU), a prediction unit (PU), or a transform unit (TU).

However, the terms are used only for convenience of illustration of the present disclosure, the present invention is not limited to the definitions of the terms. In this specification, for convenience of illustration, the term “coding unit” is employed as a unit used in a process of encoding or decoding a video signal, however, the present invention is not limited thereto, another process unit may be appropriately selected based on contents of the present disclosure.

The encoder 100 may generate a residual signal by subtracting a prediction signal output from the inter prediction unit 180 or intra prediction unit 185 from the input image signal. The generated residual signal may be transmitted to the transform unit 120.

The transform unit 120 may generate a transform coefficient by applying a transform scheme to a residual signal. The transform process may be applied a block (square or rectangle) split by a square block of a quadtree structure or a binarytree structure, a ternary structure or an asymmetric structure.

The transform unit 120 may perform a transform based on a plurality of transforms (or transform combinations), and such a transform scheme may be called MTS (Multiple Transform Selection). The MTS may also be called AMT (Adaptive Multiple Transform) or EMT (Enhanced Multiple Transform).

The MTS (or AMT, EMT) may mean a transform scheme performed based on a transform (or transform combinations) which is adaptively selected from a plurality of transforms (or transform combinations).

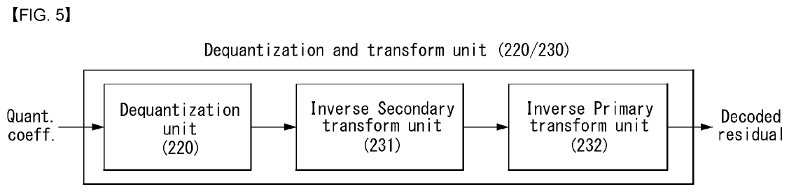

The plurality of transforms (or transform combinations) may include a transform (or transform combinations) described in FIG. 6 and FIG. 26 to FIG. 27 of the present disclosure. In the present disclosure, the transform or transform type may be denoted such as DCT-Type 2, DCT-II and DCT2.

The transform unit 120 may perform the following embodiments.

The present disclosure provides a method for performing Discrete Sine Transform-4 (DST4) and Discrete Cosine Transform-4 (DCT4) with forward DCT2.

The present disclosure provides a method for performing DST4 and DCT4 with inverse DCT2.

The present disclosure provides a method for applying DST4 and DCT4 to a transform configuration group to which Multiple Transform Selection (MTS) is applied.

Detailed embodiments thereof are described more specifically in the disclosure.

The quantization unit 130 may quantize a transform coefficient and transmit it to the entropy encoding unit 190. The entropy encoding unit 190 may entropy-code a quantized signal and output it as a bitstream.

The transform unit 120 and the quantization unit 130 are described as separate function units, but the disclosure is not limited thereto. The transform unit 120 and the quantization unit 130 may be combined into a single function unit. Likewise, the dequantization unit 140 and the transform unit 150 may be combined into a single function unit.

The quantized signal output by the quantization unit 130 may be used to generate a prediction signal. For example, a residual signal may be reconstructed by applying dequantization and an inverse transform to the quantized signal through the dequantization unit 140 and the transform unit 150 within a loop. A reconstructed signal may be generated by adding the reconstructed residual signal to a prediction signal output by the inter prediction unit 180 or the intra prediction unit 185.

Meanwhile, an artifact in which a block boundary appears may occur due to a quantization error occurring in such a compression process. Such a phenomenon is called a blocking artifact, which is one of important factors in evaluating picture quality. In order to reduce such an artifact, a filtering process may be performed. Picture quality can be improved by reducing an error of a current picture while removing a blocking artifact through such a filtering process.

The filtering unit 160 may apply filtering to the reconstructed signal and then outputs the filtered reconstructed signal to a reproducing device or the decoded picture buffer 170. The filtered signal transmitted to the decoded picture buffer 170 may be used as a reference picture in the inter-prediction unit 180. In this way, using the filtered picture as the reference picture in the inter-picture prediction mode, not only the picture quality but also the coding efficiency may be improved.

The decoded picture buffer 170 may store the filtered picture for use as the reference picture in the inter-prediction unit 180.

The inter-prediction unit 180 may perform a temporal prediction and/or a spatial prediction on the reconstructed picture in order to remove temporal redundancy and/or spatial redundancy. In this case, the reference picture used for the prediction may be a transformed signal obtained via the quantization and dequantization on a block basis in the previous encoding/decoding. Thus, this may result in blocking artifacts or ringing artifacts.

Accordingly, in order to solve the performance artifact attributable to the discontinuity or quantization of the signal, the inter-prediction unit 180 may interpolate signals between pixels on a subpixel basis using a low-pass filter. In this case, the subpixel may mean a virtual pixel generated by applying an interpolation filter. An integer pixel means an actual pixel existing in a reconstructed picture. An interpolation method may include linear interpolation, bi-linear interpolation, a Wiener filter, etc.

The interpolation filter is applied to a reconstructed picture, and thus can improve the precision of a prediction. For example, the inter prediction unit 180 may generate an interpolated pixel by applying the interpolation filter to an integer pixel, and may perform a prediction using an interpolated block configured with interpolated pixels as a prediction block.

Meanwhile, the intra prediction unit 185 may predict a current block with reference to samples peripheral to a block to be now encoded. The intra prediction unit 185 may perform the following process in order to perform intra prediction. First, the prediction unit may prepare a reference sample necessary to generate a prediction signal. Furthermore, the prediction unit may generate a prediction signal using the prepared reference sample. Thereafter, the prediction unit encodes a prediction mode. In this case, the reference sample may be prepared through reference sample padding and/or reference sample filtering. The reference sample may include a quantization error because a prediction and reconstruction process has been performed on the reference sample. Accordingly, in order to reduce such an error, a reference sample filtering process may be performed on each prediction mode used for intra prediction.

The prediction signal generated through the inter prediction unit 180 or the intra prediction unit 185 may be used to generate a reconstructed signal or may be used to generate a residual signal.

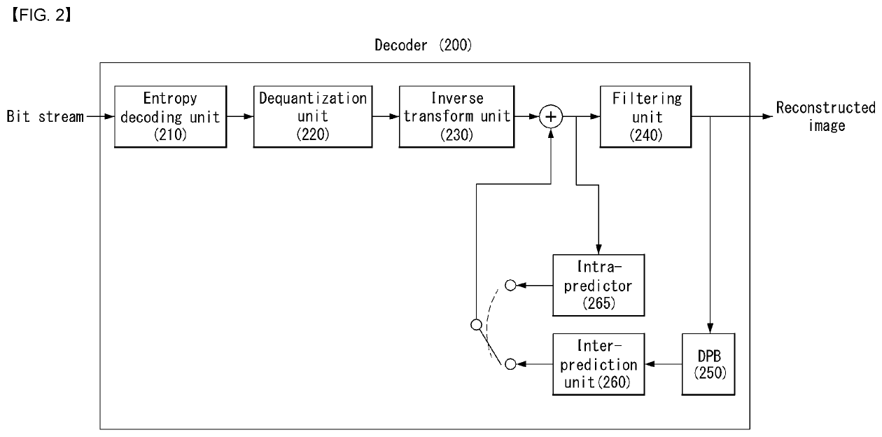

FIG. 2 is a block diagram illustrating the configuration of a decoder for decoding a video signal according to an embodiment of the present invention.

Referring to FIG. 2, the decoder 200 may be configured to include a parsing unit (not illustrated), an entropy decoding unit 210, a dequantization unit 220, a transform unit 230, a filter 240, a decoded picture buffer (DPB) 250, an inter prediction unit 260 and an intra prediction unit 265.

Furthermore, a reconstructed image signal output through the decoder 200 may be played back through a playback device.

The decoder 200 may receive a signal output by the encoder 100 of FIG. 1. The received signal may be entropy-decoded through the entropy decoding unit 210.

The dequantization unit 220 obtains a transform coefficient from the entropy-decoded signal using quantization step size information.

The transform unit 230 obtains a residual signal by inverse-transforming the transform coefficient.

In this case, the disclosure provides a method of configuring a transform combination for each transform configuration group distinguished based on at least one of a prediction mode, a block size or a block shape. The transform unit 230 may perform an inverse transform based on a transform combination configured by the disclosure. Furthermore, embodiments described in the disclosure may be applied.

The inverse transformer 230 may perform the following embodiments.

The present disclosure provides a method for performing Discrete Sine Transform-4 (DST4) and Discrete Cosine Transform-4 (DCT4) with forward DCT2.

The present disclosure provides a method for performing DST4 and DCT4 with inverse DCT2.

The present disclosure provides a method for applying DST4 and DCT4 to a transform configuration group to which Multiple Transform Selection (MTS) is applied.

In an aspect, the present disclosure provides a method for reconstructing a video signal based on low-complexity transform implementation including obtaining a transform index of a current block from the video signal, wherein the transform index corresponds to any one of a plurality of transform combinations including a combination of DST4 and/or DCT4; deriving a transform combination corresponding to the transform index, wherein the transform combination includes a horizontal transform and a vertical transform, and wherein the horizontal transform and the vertical transform correspond to at least one of the DST4 or the DCT4; performing an inverse transform in a vertical direction with respect to the current block by using the DST4; performing an inverse transform in a horizontal direction with respect to the current block by using the DCT4; and reconstructing the video signal by using the current block which the inverse transform is performed.

In the present disclosure, the DST4 and/or the DCT4 are/is executed by using a forward DCT2 or an inverse DCT2.

In the present disclosure, the DST4 and/or the DCT4 apply/applies post-processing matrix M_{N} and pre-processing A_{N} to the forward DCT2 or the inverse DCT2 (herein,

$${[ {M}_{N}^{- 1} ]}_{n , k} = \{ \begin{matrix}1 / 2 cos \frac{π ( 2 n + 1 )}{4 N} , if n = k \\ 0 , otherwise\end{matrix} n , k = 0 , 1 , … , N - 1 , \\ {[ {A}_{N}^{- 1} ]}_{n , k} = \{ \begin{matrix}\sqrt{2} , n = k = 0 \\ 1 , n = k or k + 1 , \\ 0 , otherwise\end{matrix} \\ n = 1 , 2 , … , N - 1 , k = 0 , 1 , … , N - 1 , \\ herein , N represents a block size ) .$$

In the present disclosure, the inverse transform of the DST4 is applied for each column when the vertical transform is the DST4, and wherein the inverse transform of the DCT4 is applied for each row when the horizontal transform is the DCT4.

In the present disclosure, the transform combination (horizontal transform, vertical transform) includes (DST4, DST4), (DCT4, DST4), (DST4, DCT4) and (DCT4, DCT4).

In the present disclosure, when the current block is an intra predicted residual, the transform combination corresponds to transform indexes 0, 1, 2 and 3.

In the present disclosure, when the current block is an inter predicted residual, the transform combination corresponds to transform indexes 3, 2, 1 and 0.

The dequantization unit 220 and the inverse transform unit 230 are described as separate functional units, but the present disclosure is not limited thereto, and may be combined into a single functional unit.

By adding the obtained residual signal to the prediction signal output from the inter predictor 260 or the intra predictor 265, a reconstructed signal is generated.

The filter 240 applies filtering to the reconstructed signal and outputs it to a playback device or transmits it to the decoded picture buffer 250. The filtered signal transmitted to the decoded picture buffer 250 may be used as a reference picture in the inter predictor 260.

In the present disclosure, the embodiments described in the transform unit 120 of the encoder 100 and each of the functional units may be identically applied to the inverse transform unit 230 of the decoder and the corresponding functional units.

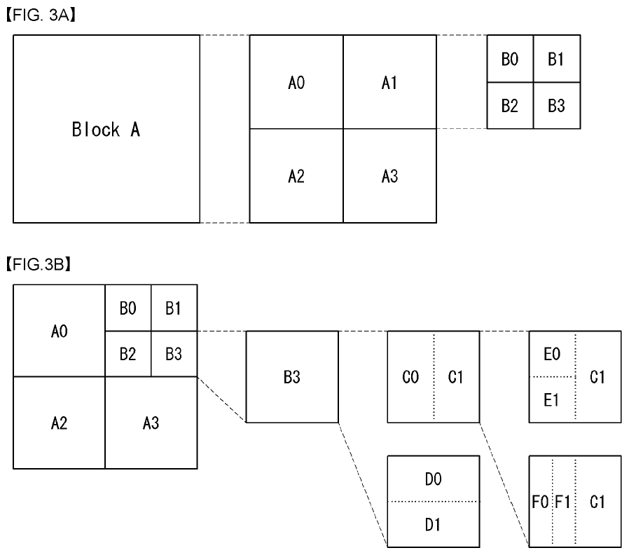

FIG. 3 illustrates embodiments to which the disclosure may be applied, FIG. 3A is a diagram for describing a block split structure based on a quadtree (hereinafter referred to as a “QT”), FIG. 3B is a diagram for describing a block split structure based on a binary tree (hereinafter referred to as a “BT”), FIG. 3C is a diagram for describing a block split structure based on a ternary tree (hereinafter referred to as a “TT”), and FIG. 3D is a diagram for describing a block split structure based on an asymmetric tree (hereinafter referred to as an “AT”).

In video coding, one block may be split based on a quadtree (QT). Furthermore, one subblock split by the QT may be further split recursively using the QT. A leaf block that is no longer QT split may be split using at least one method of a binary tree (BT), a ternary tree (TT) or an asymmetric tree (AT). The BT may have two types of splits of a horizontal BT (2N×N, 2N×N) and a vertical BT (N×2N, N×2N). The TT may have two types of splits of a horizontal TT (2N×1/2N, 2N×N, 2N×1/2N) and a vertical TT (1/2N×2N, N×2N, 1/2N×2N). The AT may have four types of splits of a horizontal-up AT (2N×1/2N, 2N×3/2N), a horizontal-down AT (2N×3/2N, 2N×1/2N), a vertical-left AT (1/2N×2N, 3/2N×2N), and a vertical-right AT (3/2N×2N, 1/2N×2N). Each BT, TT, or AT may be further split recursively using the BT, TT, or AT.

FIG. 3A shows an example of a QT split. A block A may be split into four subblocks A0, A1, A2, and A3 by a QT. The subblock A1 may be split into four subblocks B0, B1, B2, and B3 by a QT.

FIG. 3B shows an example of a BT split. A block B3 that is no longer split by a QT may be split into vertical BTs C0 and C1 or horizontal BTs D0 and D1. As in the block C0, each subblock may be further split recursively like the form of horizontal BTs E0 and E1 or vertical BTs F0 and F1.

FIG. 3C shows an example of a TT split. A block B3 that is no longer split by a QT may be split into vertical TTs C0, 01, and C2 or horizontal TTs D0, D1, and D2. As in the block C1, each subblock may be further split recursively like the form of horizontal TTs E0, E1, and E2 or vertical TTs F0, F1, and F2.

FIG. 3D shows an example of an AT split. A block B3 that is no longer split by a QT may be split into vertical ATs C0 and C1 or horizontal ATs D0 and D1. As in the block C1, each subblock may be further split recursively like the form of horizontal ATs E0 and E1 or vertical TTs F0 and F1.

Meanwhile, BT, TT, and AT splits may be split together. For example, a subblock split by a BT may be split by a TT or AT. Furthermore, a subblock split by a TT may be split by a BT or AT. A subblock split by an AT may be split by a BT or TT. For example, after a horizontal BT split, each subblock may be split into vertical BTs or after a vertical BT split, each subblock may be split into horizontal BTs. The two types of split methods are different in a split sequence, but have the same finally split shape.

Furthermore, if a block is split, the sequence that the block is searched may be defined in various ways. In general, the search is performed from left to right or from top to bottom. To search a block may mean a sequence for determining whether to split an additional block of each split subblock or may mean a coding sequence of each subblock if a block is no longer split or may mean a search sequence when information of another neighbor block is referred in a subblock.

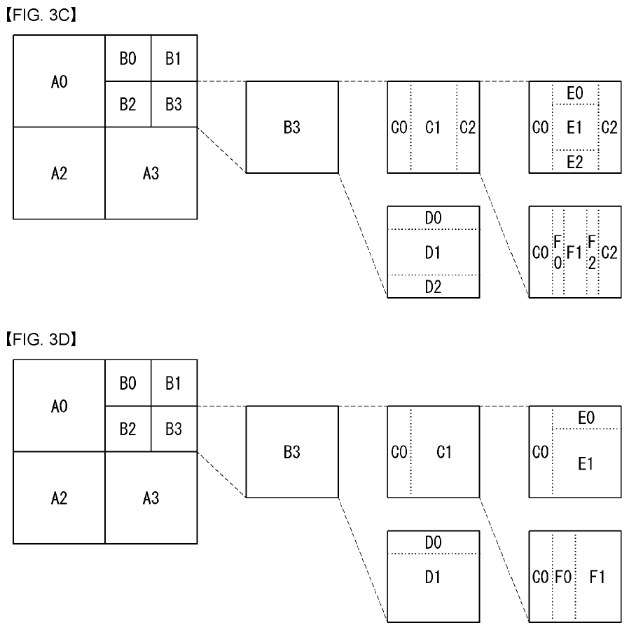

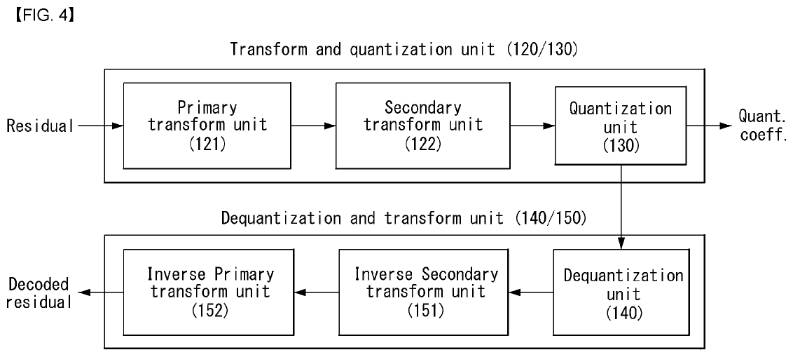

FIGS. 4 and 5 illustrate embodiments to which the present disclosure is applied. FIG. 4 illustrates a schematic block diagram of the transform and quantization units 120/130 and the dequantization and inverse transform units 140/150 in the encoder, and FIG. 5 illustrates a schematic block diagram of dequantization and inverse transform units 220/230 in the decoder.

Referring to FIG. 4, the transform and quantization units 120/130 may include a primary transform unit 121, a secondary transform unit 122 and the quantization unit 130. The dequantization and inverse transform units 140/150 may include the dequantization unit 140, an inverse secondary transform unit 151 and an inverse primary transform unit 152.

Referring to FIG. 5, the dequantization and transform unit 220/230 may include the dequantization unit 220, an inverse secondary transform unit 231 and an inverse primary transform unit 232.

In the present disclosure, when a transform is performed, the transform may be performed through a plurality of steps. For example, as shown in FIG. 4, two steps of a primary transform and a secondary transform may be applied or more transform steps may be used according to an algorithm. In this case, the primary transform may be referred to as a core transform.

The primary transform unit 121 may apply a primary transform for a residual signal. In this case, the primary transform may be predefined in a table form in the encoder and/or the decoder.

A discrete cosine transform type 2 (hereinafter, referred to as “DCT2”) may be applied to the primary transform. Alternatively, a discrete sine transform-type 7 (hereinafter, referred to as “DST7”) may be applied to a specific case. For example, in the intra prediction mode, the DST7 may be applied to a 4×4 block.

Furthermore, for the primary transform case, combinations of several transforms (DST 7, DCT 8, DST 1 and DCT 5) of the Multiple Transform Selection (MTS) may be applied to the primary transform. For example, FIG. 6 may be applied.

The secondary transform unit 122 may apply a secondary transform to the primary transformed signal. In this case, the secondary transform may be predefined in a table form in the encoder and/or the decoder.

In an embodiment, a non-separable secondary transform (hereinafter “NSST”) may be conditionally applied to the secondary transform. For example, the NSST is applied to only an intra prediction block and may have a transform set which may be applied to each prediction mode group.

In this case, the prediction mode group may be configured based on symmetry fora prediction direction. For example, prediction mode 52 and prediction mode 16 are symmetrical with respect to prediction mode 34 (diagonal direction) and may form a single group. Accordingly, the same transform set may be applied to the single group. In this case, when a transform for prediction mode 52 is applied, it is applied after input data is transposed. The reason for this is that the transform set for prediction mode 16 is the same as that for prediction mode 52.

Meanwhile, the planar mode and the DC mode have respective transform sets because symmetry for direction is not present, the respective transform set may be configured with two transforms. The remaining directional mode may be configured with three transforms for each transform set.

In another embodiment, the NSST is not applied to whole area of primary transformed block but may be applied to only a top-left 8×8 area. For example, in the case that the size of a block is 8×8 or more, an 8×8 NSST is applied. In the case that the size of a block is less than 8×8, a 4×4 NSST is applied, and in this case, after the block is split into 4×4 blocks, a 4×4 NSST is applied to each of the blocks.

In another embodiment, the 4×4 NSST may be applied even in the case of 4×N/Nx4 (N>=16).

The quantization unit 130 may perform quantization on the secondary transformed signal.

The dequantization and transform unit 140/150 inversely performs the process described above, and a repeated description thereof is omitted.

FIG. 5 illustrates a schematic block diagram of a dequantization and transform unit 220/230 within the decoder.

Referring to FIG. 5, the dequantization and transform unit 220/230 may include the dequantization unit 220, an inverse secondary transform unit 231 and an inverse primary transform unit 232.

The dequantization unit 220 obtains a transform coefficient from an entropy-decoded signal using quantization step size information.

The inverse secondary transform unit 231 performs an inverse secondary transform on the transform coefficient. In this case, the inverse secondary transform indicates an inverse transform of the secondary transform described in FIG. 4.

The inverse primary transform unit 232 performs an inverse primary transform on the inverse secondary transformed signal (or block), and obtains a residual signal. In this case, the inverse primary transform indicates an inverse transform of the primary transform described in FIG. 4.

The disclosure provides a method of configuring a transform combination for each transform configuration group distinguished by at least one of a prediction mode, a block size or a block shape. The inverse primary transform unit 232 may perform an inverse transform based on a transform combination configured by the disclosure. Furthermore, embodiments described in the disclosure may be applied.

FIG. 6 illustrates a table illustrating a transform configuration group to which Multiple Transform Selection (MTS) is applied as an embodiment to which the present disclosure is applied.

Transform Configuration Group to which Multiple Transform Selection (MTS) is Applied

In the present disclosure, an j-th transform combination candidate for a transform configuration group Gᵢ is indicated in pairs as represented in Equation 1.

(H(Gᵢ,j),V(Gᵢ,j)) [Equation]

In this case, H(Gᵢ, j) indicates a horizontal transform

In this case, H(Gᵢ, j) indicates a horizontal transform for an j-th candidate, and V(Gᵢ, j) indicates a vertical transform for the j-th candidate. For example, in FIG. 6, it is indicated that H(G₃, 2)=DST7, V(G₃, 2)=DCT8. According to the context, a value assigned to H(Gᵢ, j) or V(Gᵢ, j) may be a nominal value for distinguishing transforms as described in the example or may be an index value indicating a corresponding transform or may be a 2-dimensional matrix (2D matrix) for a corresponding transform.

Furthermore, in the present disclosure, 2D matrix values for a DCT and a DST may be represented as Equations 2 to 3 below.

DCT type 2: C_{N}^{II},DCT type 8: C_{N}^{VIII} [Equation 2]

DST type 7: S_{N}^{VII},DST type 4: S_{N}^{IV} [Equation 3]

In this case, whether a transform is a DST or a DCT is indicated as S or C, a type number is indicated as a superscript in the form of a Roman number, and N of a subscript indicates an N×N transform. Furthermore, it is assumed that in the 2D matrices, such as C_{N}^{II} and S_{N}^{IV}, column vectors form a transform basis.

Referring to FIG. 6, transform configuration groups may be determined based on a prediction mode, and the number of groups may be a total of 6 G0 to G5. Furthermore, G0 to G4 corresponds to a case where an intra prediction is applied, and G5 indicates transform combinations (or transform set, the transform combination set) applied to a residual block generated by an inter prediction.

One transform combination may be configured with a horizontal transform (or row transform) applied to the rows of a corresponding 2D block and a vertical transform (or column transform) applied to the columns of the corresponding 2D block.

In this case, each of the transform configuration groups may have four transform combination candidates. The four transform combination candidates may be selected or determined through transform combination indices 0 to 3. The encoder may encode a transform combination index and transmit it to the decoder.

In one embodiment, residual data (or a residual signal) obtained through an intra prediction may have different statistical characteristics depending on its intra prediction mode. Accordingly, as shown in FIG. 6, other transforms, not a common cosine transform, may be applied for each intra prediction mode.

FIG. 6 illustrates a case where 35 intra prediction modes are used and a case where 67 intra prediction modes are used. A plurality of transform combinations may be applied to each transform configuration group distinguished in an intra prediction mode column. For example, the plurality of transform combinations may be configured with four (row direction transform, and column direction transform) combinations. As a specific example, in group 0, a total of four combinations are available because DST-7 and DCT-5 may be applied to both a row (horizontal) direction and a column (vertical) direction.

Since a total of four transform kernel combinations may be applied to each intra prediction mode, a transform combination index for selecting one of the four transform kernel combinations may be transmitted for each transform unit. In the present disclosure, the transform combination index may be called an MTS index and may be represented as mts_idx.

Furthermore, in addition to the transform kernels proposed in FIG. 6, a case where DCT-2 is the best for both a row direction and a column direction may occur from the nature of a residual signal. Accordingly, a transform may be adaptively performed by defining an MTS flag for each coding unit. In this case, when the MTS flag is 0, DCT-2 may be applied to both the row direction and the column direction. When the MTS flag is 1, one of the four combinations may be selected or determined through an MTS index.

In one embodiment, when the AMT flag is 1, in the case that the number of non-zero transform coefficient for one transform unit is not greater than a threshold value, DST-7 may be applied to both the row direction and the column direction without applying the transform kernels of FIG. 6. For example, the threshold value may be set to 2, which may be differently set based on the size of a block size or transform unit. This may also be applied to other embodiments of the present disclosure.

In one embodiment, transform coefficient values may be first parsed. In the case that the number of non-zero transform coefficient is not greater than the threshold value, an MTS index is not parsed but DST-7 is applied, thereby being capable of reducing the amount of additional information transmitted.

In one embodiment, when the MTS flag is 1, in the case that the number of non-zero transform coefficient for one transform unit is greater than the threshold value, an MTS index is parsed, and a horizontal transform and a vertical transform may be determined based on the MTS index.

In one embodiment, an MTS may be applied to a case where both the width and height of a transform unit is 32 or less.

In one embodiment, FIG. 6 may be preconfigured through off-line training.

In one embodiment, the MTS index may be defined as one index capable of indicating a combination of a horizontal transform and a vertical transform. Alternatively, the MTS index may separately define a horizontal transform index and a vertical transform index.

In one embodiment, the MTS flag or the MTS index may be defined in at least one level of a sequence, a picture, a slice, a block, a coding unit, a transform unit or a prediction unit. For example, the MTS flag or the MTS index may be defined in at least one of a sequence parameter set (SPS) or a transform unit.

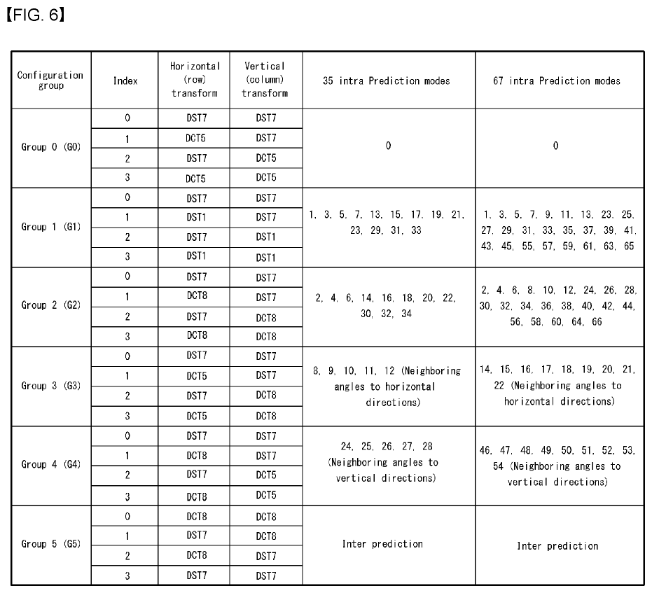

FIG. 7 is a flowchart illustrating an encoding process on which Multiple Transform Selection (MTS) is performed as an embodiment to which the present disclosure is applied.

In the present disclosure, basically, an embodiment in which transforms are separately applied to a horizontal direction and a vertical direction is described, but a transform combination may be configured with non-separable transforms.

Alternatively, separable transforms and non-separable transforms may be mixed and configured. In this case, when a non-separable transform is used, selecting transform for each row/column or for each horizontal/vertical direction is not necessary, and the transform combinations of FIG. 6 may be used only when separable transforms are selected.

Furthermore, the methods proposed in the present disclosure may be applied regardless of a primary transform or a secondary transform. That is, there is no limitation that the methods need to be applied to only either one of a primary transform or a secondary transform and may be applied to both. In this case, the primary transform may mean a transform for first transforming a residual block, and the secondary transform may mean a transform for applying a transform to a block generated as the results of the primary transform.

First, the encoder may determine a transform configuration group corresponding to a current block (step, S710). In this case, the transform configuration group may mean the transform configuration group shown in FIG. 6, but the present disclosure is not limited thereto. The transform configuration group may be configured with other transform combinations.

The encoder may perform a transform on available candidate transform combinations within the transform configuration group (step, S720).

The encoder may determine or select a transform combination having the smallest rate distortion (RD) cost based on a result of performing the transform (step, S730).

The encoder may encode a transform combination index corresponding to the selected transform combination (step, S740).

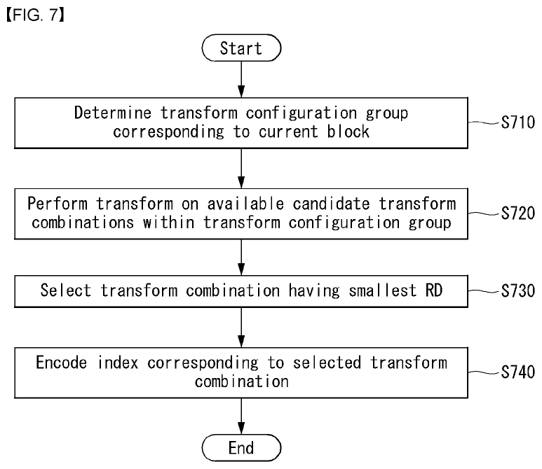

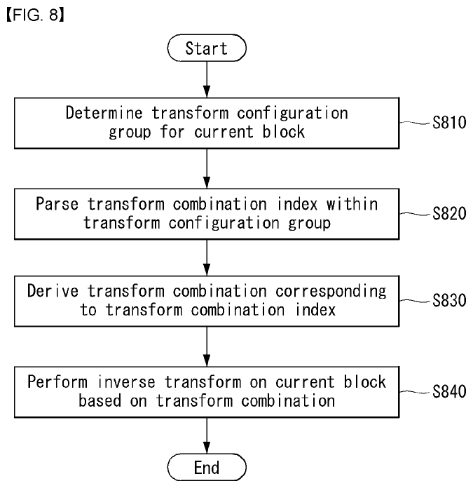

FIG. 8 is a flowchart illustrating a decoding process on which Multiple Transform Selection (MTS) is performed as an embodiment to which the disclosure is applied.

First, the decoder may determine a transform configuration group for a current block (step, S810).

The decoder may parse (or obtain) a transform combination index from a video signal. In this case, the transform combination index may correspond to any one of a plurality of transform combinations within the transform configuration group (step, S820). For example, the transform configuration group may include discrete sine transform type 7 (DST7) and discrete cosine transform type 8 (DCT8). The transform combination index may be called an MTS index.

In one embodiment, the transform configuration group may be configured based on at least one of a prediction mode, block size or block shape of a current block.

The decoder may derive a transform combination corresponding to the transform combination index (step, S830). In this case, the transform combination is configured with a horizontal transform and a vertical transform and may include at least one of the DST-7 or the DCT-8.

Furthermore, the transform combination may mean the transform combination described in FIG. 6, but the present disclosure is not limited thereto. That is, a configuration based on another transform combination according to another embodiment of the present disclosure is possible.

The decoder may perform an inverse transform on the current block based on the transform combination (step, S840). In the case that the transform combination is configured with a row (horizontal) transform and a column (vertical) transform, after the row (horizontal) transform is first applied, the column (vertical) transform may be applied. In this case, the present disclosure is not limited thereto and may be reversely applied or in the case that the transform combination is configured with non-separable transforms, the non-separable transforms may be immediately applied.

In one embodiment, in the case that the vertical transform or the horizontal transform is the DST-7 or DCT-8, an inverse transform of the DST-7 or an inverse transform of the DCT-8 may be applied for each column and then applied for each row.

In one embodiment, the vertical transform or the horizontal transform may be differently applied to each row and/or each column.

In one embodiment, the transform combination index may be obtained based on an MTS flag indicating whether an MTS is performed. That is, the transform combination index may be obtained in the case that an MTS is performed based on the MTS flag.

In one embodiment, the decoder may check whether the number of non-zero transform coefficient is greater than a threshold. In this case, the transform combination index may be obtained when the number of non-zero transform coefficient is greater than the threshold.

In one embodiment, the MTS flag or the MTS index may be defined in at least one level of a sequence, a picture, a slice, a block, a coding unit, a transform unit or a prediction unit.

In one embodiment, the inverse transform may be applied when both the width and height of a transform unit is 32 or less.

Meanwhile, in another embodiment, the process of determining a transform configuration group and the process of parsing a transform combination index may be performed at the same time. Alternatively, step S810 may be preconfigured in the encoder and/or the decoder and omitted.

FIG. 9 is a flowchart for describing a process of encoding an MTS flag and an MTS index as an embodiment to which the disclosure is applied.

The encoder may determine whether Multiple Transform Selection (MTS) is applied to a current block (step, S910).

In the case that the Multiple Transform Selection (MTS) is applied, the encoder may encode an MTS flag=1 (step, S920).

Furthermore, the encoder may determine an MTS index based on at least one of a prediction mode, horizontal transform, and vertical transform of the current block (step, S930). In this case, the MTS index means an index indicating any one of a plurality of transform combinations for each intra prediction mode, and the MTS index may be transmitted for each transform unit.

When the MTS index is determined, the encoder may encode the MTS index (step, S940).

Meanwhile, in the case that the Multiple Transform Selection (MTS) is not applied, the encoder may encode the MTS flag=0 (step, S950).

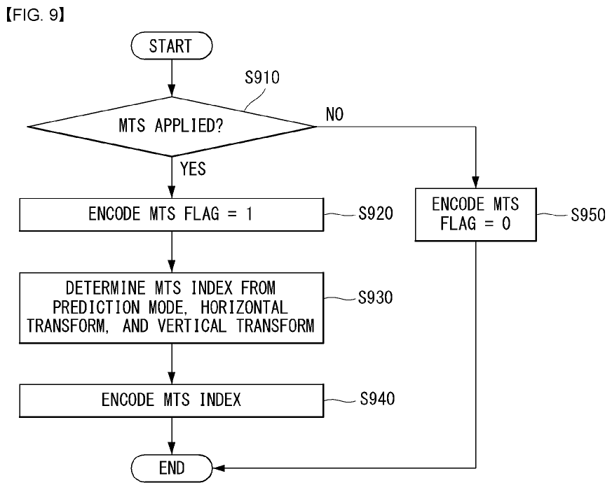

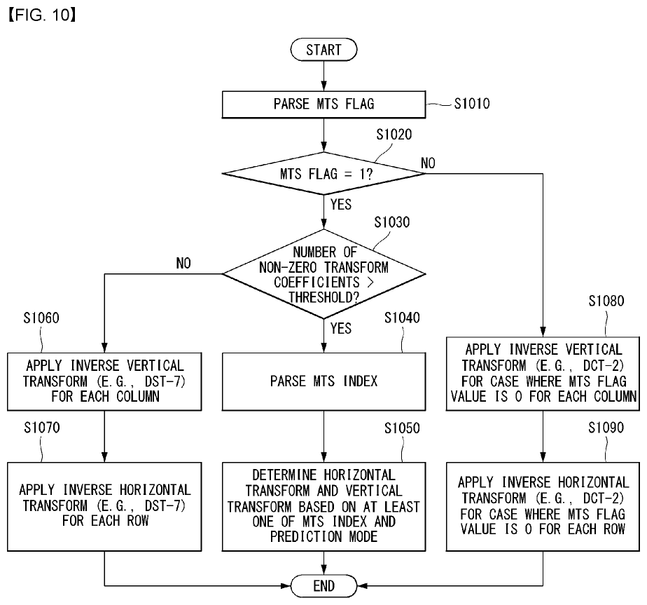

FIG. 10 is a flowchart for describing a decoding process of applying a horizontal transform or vertical transform to a row or column based on an MTS flag and an MTS index as an embodiment to which the disclosure is applied.

The decoder may parse an MTS flag from a bitstream (step, S1010). In this case, the MTS flag may indicate whether Multiple Transform Selection (MTS) is applied to a current block.

The decoder may check whether the Multiple Transform Selection (MTS) is applied to the current block based on the AMT flag (step, S1020). For example, the decoder may check whether the MTS flag is 1.

In the case that the MTS flag is 1, the decoder may check whether the number of non-zero transform coefficient is greater than a threshold value (or more) (step, S1030). For example, the threshold value may be set to 2. This may be differently set based on a block size or the size of a transform unit.

In the case that the number of non-zero transform coefficient is greater than the threshold value, the decoder may parse the MTS index (step, S1040). In this case, the MTS index means an index indicating any one of a plurality of transform combinations for each intra prediction mode or inter prediction mode. The MTS index may be transmitted for each transform unit. Alternatively, the MTS index may mean an index indicating any one transform combination defined in a preset transform combination table. The preset transform combination table may mean FIG. 6, but the present disclosure is not limited thereto.

The decoder may derive or determine a horizontal transform and a vertical transform based on at least one of the MTS index or a prediction mode (step, S1050).

Alternatively, the decoder may derive a transform combination corresponding to the MTS index. For example, the decoder may derive or determine a horizontal transform and vertical transform corresponding to the MTS index.

Meanwhile, in the case that the number of non-zero transform coefficient is not greater than a threshold value, the decoder may apply a preset vertical inverse transform to each column (step, S1060). For example, the vertical inverse transform may be an inverse transform of DST7.

Furthermore, the decoder may apply a preset horizontal inverse transform to each row (step, S1070). For example, the horizontal inverse transform may be an inverse transform of DST7. That is, in the case that the number of non-zero transform coefficient is not greater than the threshold, a transform kernel preset in the encoder or the decoder may be used. For example, not the transform kernels defined in the transform combination table of FIG. 6, but commonly used transform kernels may be used.

Meanwhile, when the AMT flag is 0, the decoder may apply a preset vertical inverse transform to each column (step, S1080). For example, the vertical inverse transform may be an inverse transform of DCT-2.

Furthermore, the decoder may apply a preset horizontal inverse transform to each row (step, S1090). For example, the horizontal inverse transform may be an inverse transform of DCT-2. That is, when the AMT flag is 0, a transform kernel preset in the encoder or the decoder may be used. For example, not the transform kernels defined in the transform combination table of FIG. 6, but commonly used transform kernels may be used.

FIG. 11 Illustrates a schematic block diagram of the inverse transform unit as an embodiment to which the present disclosure is applied.

The decoding apparatus to which the present disclosure is applied may include a secondary inverse transform application determination unit (or an element for determining whether a secondary inverse transform is applied) 1110, a secondary inverse transform determination unit (or an element for determining a secondary inverse transform) 1120, a secondary inverse transform unit (or an element for performing a secondary inverse transform) 1130 and a primary inverse transform unit (or an element for performing a primary inverse transform) 1140.

The secondary inverse transform application determination unit 1110 may determine whether to apply the secondary inverse transform. For example, the secondary inverse transform may be Non-Separable Secondary Transform (hereinafter, NSST) or Reduced Secondary Transform (hereinafter, RST). In one example, the secondary inverse transform application determination unit 1110 may determine whether to apply the second inverse transform based on a secondary transform flag received from the encoder. In another example, the secondary inverse transform application determination unit 1110 may determine whether to apply the second inverse transform based on a transform coefficient of a residual block.

The secondary inverse transform determination unit 1120 may determine a secondary inverse transform. In this case, the secondary inverse transform determination unit 1120 determine a secondary inverse transform applied to the current block based on NSST (or RST) designated according to the intra prediction mode.

In addition, in one embodiment, a secondary transform determination method may be determined based on a primary transform determination method. Various combinations of the primary transform and the secondary transform may be determined based on the intra prediction mode.

Furthermore, in one example, the secondary inverse transform determination unit 1120 may determine an area to which a secondary inverse transform is applied based on a size of the current block.

The secondary inverse transform unit 1130 may perform a secondary inverse transform for a dequantized residual block by using the determined secondary inverse transform.

The primary inverse transform unit 1140 may perform a primary inverse transform for a secondary inverse-transformed residual block. The primary transform may be indicated as a core transform. In one embodiment, the primary inverse transform unit 1140 may perform a primary transform by using the MTS described above. In addition, in one example, the primary inverse transform unit 1140 may determine whether the MTS is applied to the current block.

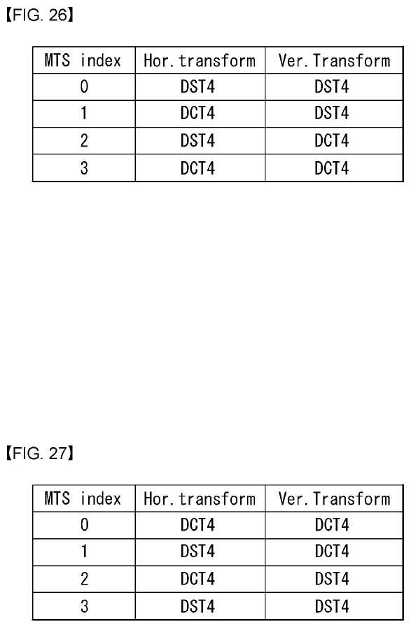

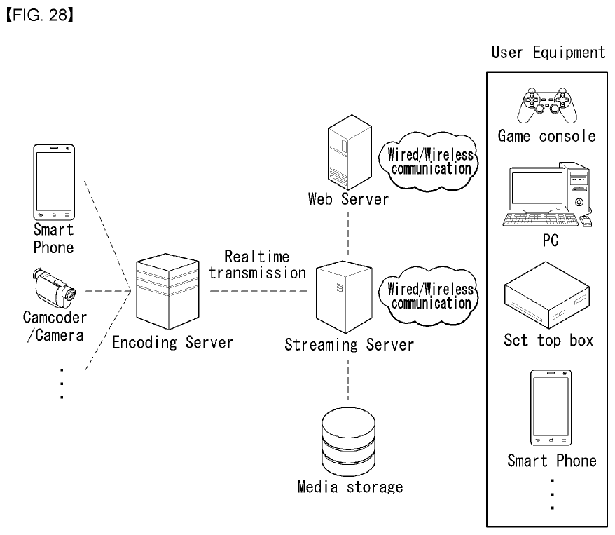

For example, in the case that the MTS is applied to the current block (i.e., tu_mts_flag=1), the primary inverse transform unit 1140 may construct MTS candidates based on the intra prediction mode of the current block. For example, the MTS candidate may be constructed in a combination of DST4 and/or DCT4 or include a combination of DST7 and/or DCT8. Alternatively, the MTS candidate may include at least one of embodiments of FIG. 6 above, the embodiments of FIG. 26 and FIG. 27 described below.

In addition, the primary inverse transform unit 1140 may determine a primary transform applied to the current block by using mts_idx indicating a specific MTS among the constructed MTS candidates.

The embodiments described above may be individually used, but the present disclosure is not limited thereto, and the embodiments may be used in combination of the above embodiment and other embodiments of the present disclosure.

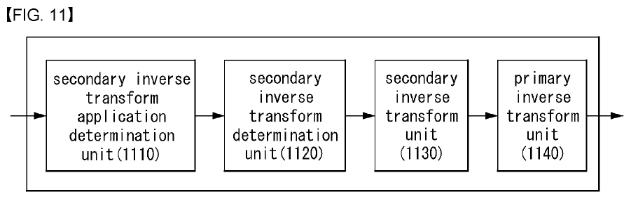

FIG. 12 illustrates a block diagram for performing an inverse transform based on a transform related parameter as an embodiment to which the present disclosure is applied.

The decoder 200 to which the present disclosure is applied may include an element for obtaining a sequence parameter 1210, an element for obtaining a Multiple Transform Selection flag (MTS flag) 1220, an element for obtaining a Multiple Transform Selection index (MTS index) 1230 and an element for deriving a transform kernel 1240.

The element for obtaining a sequence parameter 1210 may obtain sps_mts_intra_enabled_flag or sps_mts_inter_enabled_flag. Here, sps_mts_intra_enabled_flag indicates whether tu_mts_flag is present in a residual coding syntax of an intra coding unit, and sps_mts_inter_enabled_flag indicates whether tu_mts_flag is present in a residual coding syntax of an inter coding unit. As a specific example, the description of FIG. 12 may be applied.

The element for obtaining a Multiple Transform Selection flag (MTS flag) 1220 may obtain tu_mts_flag based on sps_mts_intra_enabled_flag or sps_mts_inter_enabled_flag. For example, when sps_mts_intra_enabled_flag=1 or sps_mts_inter_enabled_flag=1, the element for obtaining a Multiple Transform Selection flag (MTS flag) 1220 may obtain tu_mts_flag. Here, tu_mts_flag may indicate whether the Multiple Transform Selection is applied to a residual sample of a luma transform block. As a specific example, the description of FIG. 12 may be applied.

The element for obtaining a Multiple Transform Selection index (MTS index) 1230 may obtain mts_idx based on tu_mts_flag. For example, when tu_mts_flag=1, the element for obtaining a Multiple Transform Selection index (MTS index) 1230 may obtain mts_idx. Here, mts_idx indicates whether a certain transform kernel is applied to luma residual samples according to horizontal direction and/or vertical direction of the current block. For example, at least one of the embodiments of FIG. 6 above, the embodiments of FIG. 26 and FIG. 27 described below may be applied.

The element for deriving a transform kernel 1240 may derive a transform kernel corresponding to mts_idx.

Furthermore, the decoder 200 may perform an inverse transform based on the transform kernel.

The embodiments described above may be individually used, but the present disclosure is not limited thereto, and the embodiments may be used in combination of the above embodiment and other embodiments of the present disclosure.

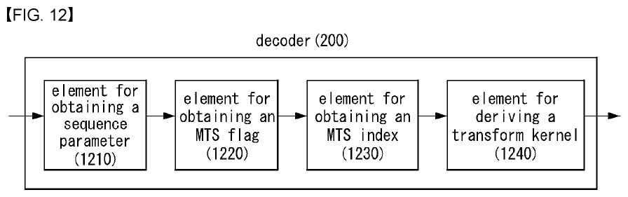

FIG. 13 illustrates a flowchart for performing an inverse transform based on a transform related parameter as an embodiment to which the present disclosure is applied.

The decoder to which the present disclosure is applied may obtain sps_mts_intra_enabled_flag or sps_mts_inter_enabled_flag (step, S1310). Here, sps_mts_intra_enabled_flag indicates whether tu_mts_flag is present in a residual coding syntax of an intra coding unit. For example, when sps_mts_intra_enabled_flag=0, tu_mts_flag is not present in a residual coding syntax of an intra coding unit, and when sps_mts_intra_enabled_flag=1, tu_mts_flag is present in a residual coding syntax of an intra coding unit. In addition, sps_mts_inter_enabled_flag indicates whether tu_mts_flag is present in a residual coding syntax of an inter coding unit. For example, when sps_mts_inter_enabled_flag=0, tu_mts_flag is not present in a residual coding syntax of an inter coding unit, and when sps_mts_inter_enabled_flag=, tu_mts_flag is present in a residual coding syntax of an inter coding unit.

The decoder may obtain tu_mts_flag based on sps_mts_intra_enabled_flag or sps_mts_inter_enabled_flag (step, S1320). For example, when sps_mts_intra_enabled_flag=1 or sps_mts_inter_enabled_flag=1, the decoder may obtain tu_mts_flag. Here, tu_mts_flag may indicate whether the Multiple Transform Selection (hereinafter, referred to as “MTS) is applied to a residual sample of a luma transform block. For example, when tu_mts_flag is 0, the MTS is not applied to a residual sample of a luma transform block, and when tu_mts_flag is 1, the MTS is applied to a residual sample of a luma transform block.

As another example, at least one of the embodiments of the present disclosure may be applied to the tu_mts_flag.

The decoder may obtain mts_idx based on tu_mts_flag (step, S1330). For example, when tu_mts_flag=1, the decoder may obtain mts_idx. Here, mts_idx indicates whether a certain transform kernel is applied to luma residual samples according to horizontal direction and/or vertical direction of the current block.

For example, at least one of the embodiments of the present disclosure may be applied to the mts_idx. As a specific example, at least one of the embodiments of FIG. 6 above, the embodiments of FIG. 26 and FIG. 27 described below may be applied.

The decoder may derive a transform kernel corresponding to mts_idx (step, S1340). For example, a transform kernel corresponding to the mts_idx may be defined as a horizontal transform and a vertical transform in a distinguished manner.

In another example, different transform kernels may be applied to the horizontal transform and the vertical transform. However, the present disclosure is not limited thereto, and the same transform kernels may be applied to the horizontal transform and the vertical transform.

Furthermore, the decoder may perform an inverse transform based on the transform kernel (step, S1350).

The embodiments described above may be individually used, but the present disclosure is not limited thereto, and the embodiments may be used in combination of the above embodiment and other embodiments of the present disclosure.

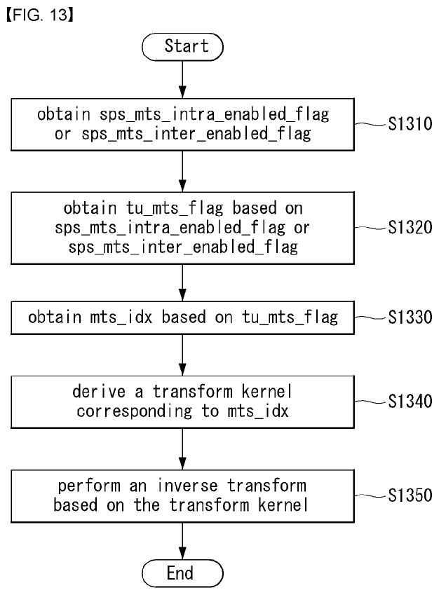

FIG. 14 illustrates an encoding flowchart for performing Discrete Sine Transform-4 (DST4) and Discrete Cosine Transform-4 (DCT4) with forward DCT2 or inverse DCT2 as an embodiment to which the present disclosure is applied.

The encoder may determine (or select) a horizontal transform and/or a vertical transform based on at least one of a prediction mode of a current block, a block shape and/or a block size (step, S1410). In this case, the candidates of the horizontal transform and/or the vertical transform may include at least one of the embodiments of FIG. 6 above, the embodiments of FIG. 26 and/or FIG. 27 described below.

The encoder may determine optimal horizontal transform and/or vertical transform through Rate Distortion (RD) optimization. The optimal horizontal transform and/or the optimal vertical transform may correspond to one of a plurality of transform combinations, and the plurality of transform combinations may be defined by transform indexes.

The encoder may signal a transform index that corresponds to the optimal horizontal transform and/or the optimal vertical transform (step, S1420). In this case, other embodiments described in the present disclosure may be applied to the transform index. For example, the embodiments may include at least one of the embodiments of FIG. 6 above, the embodiments of FIG. 26 and FIG. 27 described below.

In another example, a horizontal transform index for the optimal horizontal transform and a vertical transform index for the optimal vertical transform may be independently signaled.

The encoder may perform a forward transform in a horizontal direction for the current block by using the optimal horizontal transform (step, S1430). In this case, the current block may mean a transform block.

Furthermore, the encoder may perform a forward transform in a vertical direction for the current block by using the optimal vertical transform (step, S1440). In this embodiment, the vertical transform is performed after the horizontal transform is performed, but the present disclosure is not limited thereto. That is, the horizontal transform may be performed after the vertical transform is performed first.

In one embodiment, forward DST4 may be applied in a horizontal direction forward transform in step S1430, and then, forward DCT4 may be applied in a vertical direction forward transform in step S1440. Alternatively, the opposite case is also available.

In one embodiment, a combination of the horizontal transform and the vertical transform may include at least one of the embodiments of FIG. 6 above, the embodiments of FIG. 26 and FIG. 27 described below.

Meanwhile, the encoder may generate a transform coefficient block by performing a quantization for the current block (step, S1450).

The encoder may generate a bitstream by performing an entropy encoding for the transform coefficient block.

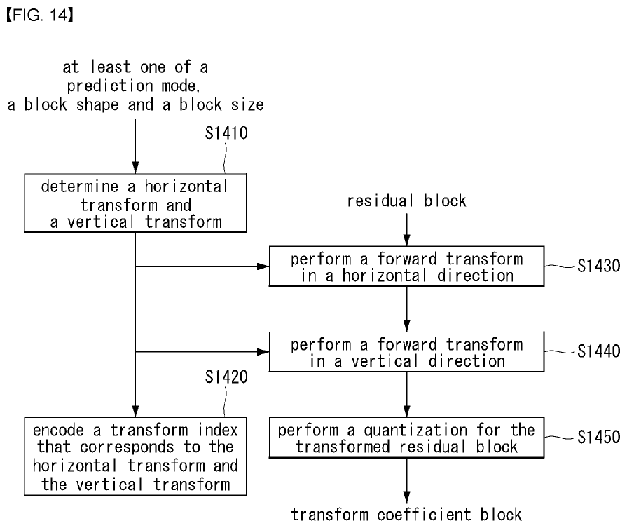

FIG. 15 illustrates a decoding flowchart for performing Discrete Sine Transform-4 (DST4) and Discrete Cosine Transform-4 (DCT4) with forward DCT2 or inverse DCT2 as an embodiment to which the present disclosure is applied.

The decoder may obtain a transform index from a bitstream (step, S1510). In this case, different embodiments described in the present disclosure may be applied to the transform index. For example, the embodiment may include at least one of the embodiments of FIG. 6 above, the embodiments of FIG. 26 and/or FIG. 27 described below.

The decoder may derive a horizontal transform and a vertical transform that correspond to the transform index (step, S1520). In this case, the candidates of the horizontal transform and/or the vertical transform may include at least one of the embodiments of FIG. 6 above, the embodiments of FIG. 26 and/or FIG. 27 described below.

However, steps S1510 and S1520 are based on just an embodiment, but the present disclosure is not limited thereto. For example, the decoder may derive a horizontal transform and a vertical transform based on at least one of a prediction mode of a current block, a block shape and/or a block size. In another embodiment, the transform index may include a horizontal transform index for the horizontal transform and a vertical transform index for the vertical transform.

Meanwhile, the decoder may obtain a transform coefficient block by entropy-decoding the bitstream and perform a dequantization for the transform coefficient block (step, S1530).

The decoder may perform an inverse direction transform in a vertical direction by using the vertical transform the dequantized transform coefficient block (step, S1540).

Furthermore, the decoder may perform an inverse direction transform in a horizontal direction by using the horizontal transform (step, S1550).

In this embodiment, the horizontal transform is applied after the vertical transform is applied, but the present disclosure is not limited thereto. That is, the vertical transform may be applied after the horizontal transform is applied first.

In one embodiment, inverse DST4 may be applied in a vertical direction inverse transform in step S1540, and then, inverse DCT4 may be applied in a horizontal direction inverse transform in step S1440. Alternatively, the opposite case is also available.

In one embodiment, a combination of the horizontal transform and the vertical transform may include at least one of the embodiments of FIG. 6 above, the embodiments of FIG. 26 and FIG. 27 described below.

The decoder generates a residual block through step S1550, and a reconstructed block is generated by adding the residual block and a prediction block.

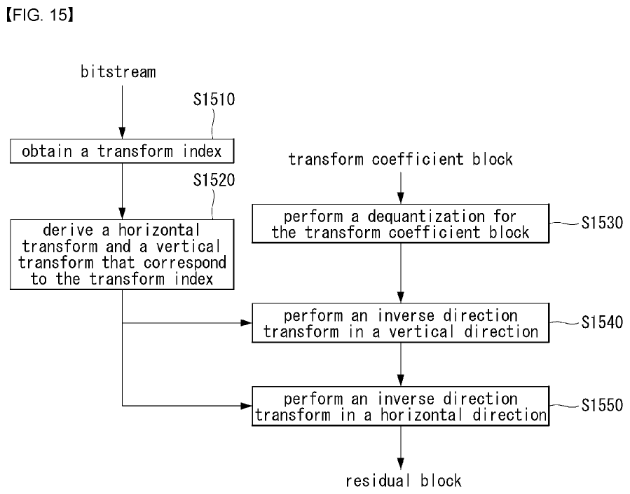

FIG. 16 illustrates diagonal elements for a pair of a transform block size N and a shift amount S₁ in a right side when DST4 and DCT4 are performed in forward DCT2 as an embodiment to which the present disclosure is applied.

The present disclosure provides a method for reducing memory use and operation complexity for Discrete Sine Transform-4 (DST4) and Discrete Cosine Transform-4 (DCT4) among transform kernels for video compression.

In one embodiment, the present disclosure provides a method for performing Discrete Sine Transform-4 (DST4) and Discrete Cosine Transform-4 (DCT4) in forward DCT2.

In one embodiment, the present disclosure provides a method for performing DST4 and DCT4 with inverse DCT2.

In one embodiment, the present disclosure provides a method for applying DST4 and DCT4 to a transform configuration group to which Multiple Transform Selection (MTS) is applied.

### Embodiment 1: Design of DST4 and DCT4 with DCT2

Equations for deriving matrixes of DST4 and DCT4 are as below.

$$\begin{matrix}{[ {S}_{N}^{IV} ]}_{n , k} = \sqrt{\frac{2}{N}} sin [ ( n + \frac{1}{2} ) ( k + \frac{1}{2} ) \frac{π}{N} ] , \\ k , n = 0 , 1 , … , N - 1 & [ Equation 4 ] \\ {[ {C}_{N}^{IV} ]}_{n , k} = \sqrt{\frac{2}{N}} cos [ ( n + \frac{1}{2} ) ( k + \frac{1}{2} ) \frac{π}{N} ] , \\ k , n = 0 , 1 , … , N - 1 & [ Equation 5 ]\end{matrix}$$

Herein, n (0, . . . N−1) represents a row index, and k (0, . . . N−1) represents a column index. In this case, Equations 4 and 5 above generate inverse transform matrixes of DST4 and DCT4, respectively. Furthermore, transpose of the matrixes represents forward transform matrixes.

When DST4 (DCT4) inverse transform matrix is represented with (S_{N}^{IV}) ((C_{N}^{IV})), a relation between Equations 6 and 7 may be identified.

$$\begin{matrix} {( {S}_{N}^{IV} )}^{T} = ( {S}_{N}^{IV} ) , {( {C}_{N}^{IV} )}^{T} = ( {C}_{N}^{IV} ) & [ Equation 6 ] \\ ( {S}_{N}^{IV} ) = {J}_{N} ( {C}_{N}^{IV} ) {D}_{N} = {( {S}_{N}^{IV} )}^{T} = {{D}_{N} ( {C}_{N}^{IV} )}^{T} {J}_{N} = {D}_{N} ( {C}_{N}^{IV} ) {J}_{N} \\ ( {C}_{N}^{IV} ) = {J}_{N} ( {S}_{N}^{IV} ) {D}_{N} = {( {C}_{N}^{IV} )}^{T} = {{D}_{N} ( {S}_{N}^{IV} )}^{T} {J}_{N} = {D}_{N} ( {S}_{N}^{IV} ) {J}_{N} \\ {where [ {J}_{N} ]}_{i , j} = \{ \begin{matrix}1 , & j = N - 1 - i \\ 0 , & otherwise\end{matrix} , i , j = 0 , 1 , … , N - 1 \\ {and [ {D}_{N} ]}_{i , j} = diag ( {( - 1 )}^{i} ) = \{ \begin{matrix}{( - 1 )}^{i} , & i = j \\ 0 , & i \neq j\end{matrix} , \\ i , j = 0 , 1 , … , N - 1 & [ Equation 7 ]\end{matrix}$$

According to Equations 6 and 7 above, according to the present disclosure, DST4 (DCT4) inverse transform matrix (S_{N}^{IV}) ((C_{N}^{IV})) may be derived from DCT4 (DST4) inverse transform matrix (S_{N}^{IV}) ((C_{N}^{IV})) by changing an input or output order and changing a sign through a pre-processing stage or post-processing stage.

Consequently, in the case of performing DST4 or DCT4 according to the present disclosure, one may be easily derived from another without additional calculation.

In one embodiment of present disclosure, DCT4 may be represented by using DCT2 as below.

$${( {C}_{N}^{IV} )}^{T} = ( {C}_{N}^{IV} ) = {{A}_{N} ( {C}_{N}^{II} )}^{T} {M}_{N} , \\ {where [ {A}_{N} ]}_{n , k} = \{ \begin{matrix}{( - 1 )}^{n} \cdot \frac{1}{\sqrt{2}} , k = 0 , n = 0 , 1 , … , N - 1 \\ {( - 1 )}^{n + k} , n \leq k , n , k = 1 , 2 , … , N - 1 \\ 0 , otherwise\end{matrix} , \\ {and [ {M}_{N} ]}_{n , k} = \{ \begin{matrix}2 cos \frac{π ( 2 n + 1 )}{4 N} , if n = k \\ 0 , otherwise\end{matrix} n , k = 0 , 1 , … , N - 1 \qquad [ Equation 8 ]$$

Herein, M_{N} indicates a post-processing matrix, and A_{N} indicates a pre-processing matrix.

(C_{N}^{IV}) of Equation 8 indicates inverse DCT2, and examples of M_{N} and A_{N} may be as below,

$${A}_{4} = [ \begin{matrix}1 / \sqrt{2} & 0 & 0 & 0 \\ 1 - / \sqrt{2} & 1 & 0 & 0 \\ 1 / \sqrt{2} & - 1 & 1 & 0 \\ - 1 / \sqrt{2} & 1 & - 1 & 1\end{matrix} ] , \\ {M}_{4} = [ \begin{matrix}2 cos \frac{π}{16} & 0 & 0 & 0 \\ 0 & 2 cos \frac{3 π}{16} & 0 & 0 \\ 0 & 0 & 2 cos \frac{5 π}{16} & 0 \\ 0 & 0 & 0 & 2 cos \frac{7 π}{16}\end{matrix} ] .$$

According to the present disclosure, it is identified that DCT4 may be designed based on post-processing matrix M_{N}, pre-processing matrix A_{N} and DCT2 from Equation 8. Here, in the case of post-processing matrix M_{N}, pre-processing matrix A_{N}, only a small amount of multiplication is added. Furthermore, DCT2 may reduce the number of coefficients to be stored and is known for a transform for fast implementation based on symmetry between coefficients in DCT2 matrix.

Accordingly, by adding a small amount of multiplication factor, the fast implementation of DCT4 may be realized with low complexity. This is also applied to DST4 case.

Inverse matrixes of post-processing matrix M_{N} and pre-processing matrix A_{N} may be represented as Equation 9 below.

$${[ {M}_{N}^{- 1} ]}_{n , k} = \{ \begin{matrix}1 / 2 cos \frac{π ( 2 n + 1 )}{4 N} , if n = k \\ 0 , otherwise\end{matrix} \\ n , k = 0 , 1 , … , N - {1 \\ [ {A}_{N}^{- 1} ]}_{n , k} = \{ \begin{matrix}\sqrt{2} , n = k = 0 \\ 1 , n = k or k + 1 , \\ 0 , otherwise\end{matrix} \\ n = 1 , 2 , … , N - 1 , k = 0 , 1 , … , N - 1 \qquad [ Equation 9 ]$$

Here, examples of AN and M_{N}⁻¹ may be

$${A}_{4}^{- 1} = [ \begin{matrix}\sqrt{2} & 0 & 0 & 0 \\ 1 & 1 & 0 & 0 \\ 0 & 1 & 1 & 0 \\ 0 & 0 & 1 & 1\end{matrix} ] , \\ {M}_{4}^{- 1} = [ \begin{matrix}1 / 2 cos \frac{π}{16} & 0 & 0 & 0 \\ 0 & 1 / 2 cos \frac{3 π}{16} & 0 & 0 \\ 0 & 0 & 1 / 2 cos \frac{5 π}{16} & 0 \\ 0 & 0 & 0 & 1 / 2 cos \frac{7 π}{16}\end{matrix} ] .$$

By using A_{N}⁻¹ and M_{N}⁻¹ of Equation 9, according to the present disclosure, another relation between DCT4 and DCT2 may be derived as represented in Equation 10 below.

(C_{N}^{IV})^{T}=(C_{N}^{IV})=M_{N}⁻¹(C_{N}^{II})A_{N}⁻¹ [Equation 10]

Here, since A_{N}⁻¹ and M_{N}⁻¹ include multiplications simpler than (CN), the fast implementation of DCT4 is available with low complexity. In addition, A_{N}⁻¹ causes the number of additions and subtractions fewer than A_{N}, but the coefficients in M_{N}⁻¹ may have wider range than M_{N}. Therefore, according the present disclosure, considering tradeoff between complexity and performance, a transform type may be designed based on Equations 9 and 10 above.

From Equations 7, 8 and 10, according the present disclosure, a low-complexity DST4 may be performed by reusing the fast implementation of DCT2. This is shown in Equations 11 and 12 below.

$$\begin{matrix} {( {S}_{N}^{IV} )}^{T} = ( {S}_{N}^{IV} ) = ( {D}_{N} {A}_{N} ) \cdot {( {C}_{N}^{II} )}^{T} \cdot ( {M}_{N} {J}_{N} ) , {where \\ [ {D}_{N} {A}_{N} ]}_{n , k} = \{ \begin{matrix}\frac{1}{\sqrt{2}} , k = 0 , n = 0 , 1 , … , N - 1 \\ {( - 1 )}^{k} , n \leq k , n , k = 1 , 2 , … , N - 1 \\ 0 , otherwise\end{matrix} and & [ Equation 11 ] \\ {[ {M}_{N} {J}_{N} ]}_{n , k} = \{ \begin{matrix}2 cos \frac{π ( 2 ( N - 1 - n ) + 1 )}{4 N} , if n = N - 1 - k \\ 0 , otherwise\end{matrix} \\ n , k = 0 , 1 , … , N - 1 & \\ {( {S}_{N}^{IV} )}^{T} = ( {S}_{N}^{IV} ) = ( {D}_{N} {M}_{N}^{- 1} ) \cdot {( {C}_{N}^{II} )}^{T} \cdot ( {A}_{N}^{- 1} {J}_{N} ) , where & [ Equation 12 ] \\ {[ {D}_{N} {M}_{N}^{- 1} ]}_{n , k} = \{ \begin{matrix}{( - 1 )}^{n} / 2 cos \frac{π ( 2 n + 1 )}{4 N} , if n = k \\ 0 , otherwise\end{matrix} \\ n , k = 0 , 1 , … , N - 1 and & \\ {[ {A}_{N}^{- 1} {J}_{N} ]}_{n , k} = \{ \begin{matrix}\sqrt{2} , n = 0 , k = N - 1 \\ 1 , k = N - n or N - 1 - n , n = 1 , 2 , … , N - 1 \\ 0 , otherwise\end{matrix} & \end{matrix}$$

### Embodiment 2: Implementation of DST4 and DCT4 with Forward DCT2

In the case that Equation 11 above is used for implementation of DST4, first, an input vector of length N needs to be scaled as much as (M_{N}J_{N}). Similarly, in the case that Equation 8 above is used for implementation of DCT4, first, an input vector of length N needs to be scaled as much as (M_{N}).

The diagonal elements in M_{N} are floating point numbers, and these needs to be properly scaled to be used in fixed-point or integer multiplications. When the integerized (M_{N}J_{N}) and M_{N} are represented as (M_{N}J_{N})′ and M_{N}′, (M_{N}J_{N})′ and M_{N}′ may be calculated according to Equation 13, respectively.

$${[ {M}_{N}^{′} ]}_{n , k} = \{ \begin{matrix}round \{ [ 2 cos \frac{π ( 2 n + 1 )}{4 N} ] << {S}_{1} \} , if n = k \\ 0 , otherwise\end{matrix} \\ n , k = 0 , 1 , … , N - {1 \\ [ {( {M}_{N} {J}_{N} )}^{′} ]}_{n , k} = \{ \begin{matrix}round \{ [ 2 cos \frac{π ( 2 ( N - 1 - n ) + 1 )}{4 N} ] << {S}_{1} \} , if n = N - 1 - k \\ 0 , otherwise\end{matrix} \\ n , k = 0 , 1 , … , N - 1 \qquad [ Equation 13 ]$$

FIG. 16 shows examples of M_{N}′ based on N and S₁. Herein, diag(·) means that an argument matrix is transformed to an associated vector constructing diagonal elements in the argument matrix.

diag((M_{N}J^{N})′) of the same (N, S₁) may be easily derived from FIG. 16 by changing element order of each vector. For example, [251,213,142,50] may be changed to [50,142,213,251].

According to the present disclosure, S₁ may be differently set for each N. For example, for 4×4 transform, S₁ may be set to 7, and for 8×8 transform, S₁ may be set to 8.

S₁ of Equation 13 indicates a left shift amount for scaling as much as 2^{S}^{₁}, and “round” operator performs an appropriate rounding.

M_{N} and (M_{N}J_{N})′ are diagonal matrixes, i^{th} element of input vector x (denoted by xᵢ) is multiplied as much as [M_{N}′]_{i,i} and [(M_{N}J_{N})′]_{i,i}. The result of multiplication of input vector x and diagonal matrixes may be represented as Equation 14 below.

$$\hat{x} = \{ \begin{matrix}{[ \begin{matrix}{x}_{0} \cdot {[ {M}_{N}^{′} ]}_{0 , 0} & {x}_{1} \cdot {[ {M}_{N}^{′} ]}_{1 , 1} & … & {x}_{N - 1} \cdot {[ {M}_{N}^{′} ]}_{N - 1 , N - 1}\end{matrix} ]}^{T} for DCT 4 \\ {[ \begin{matrix}{x}_{0} \cdot {[ {( {M}_{N} {J}_{N} )}^{′} ]}_{0 , 0} & {x}_{1} \cdot {[ {( {M}_{N} {J}_{N} )}^{′} ]}_{1 , 1} & … & {x}_{N - 1} \cdot {[ {( {M}_{N} {J}_{N} )}^{′} ]}_{N - 1 , N - 1}\end{matrix} ]}^{T} = \\ {[ \begin{matrix}{x}_{0} \cdot {[ {M}_{N}^{′} ]}_{N - 1 , N - 1} & {x}_{1} \cdot {[ {M}_{N}^{′} ]}_{N - 2 , N - 2} & … & {x}_{N - 1} \cdot {[ {M}_{N}^{′} ]}_{0 , 0}\end{matrix} ]}^{T} for DST 4\end{matrix} \qquad [ Equation 14 ]$$

\hat{x} of Equation 14 above represent the result of multiplication. However, is needs to be scaled-down thereafter. Down scaling of is may be performed before applying DCT2, performed after applying DCT2 or performed after multiplying DCT4 (DST4) to A_{N} ((D_{N}A_{N})). In the case that Down scaling of is is performed before applying DCT2, the down-scaled one, is may be determined based on Equation 15 below.

$${\tilde{x}}_{i} = \{ \begin{matrix}( {\hat{x}}_{i} + ( 1 - << ( {S}_{2} - 1 ) ) ) >> {S}_{2} , & ( 1 ) \\ {\hat{x}}_{i} >> {S}_{2} , & ( 2 ) \\ Other functions & \end{matrix} \\ if 0 , 1 , … , N - 1 \qquad [ Equation 15 ]$$

In Equation 15 above, S₂ may have the same value of S₁. However, the present disclosure is not limited thereto, and S₂ may have different value from S₁.

In Equation 15 above, any types of scaling and rounding are available, and in one embodiment, (1) and (2) of Equation 15 may be used. That is, as represented in Equation 15, (1), (2) or other functions may be applied to find \tilde{x}ᵢ.

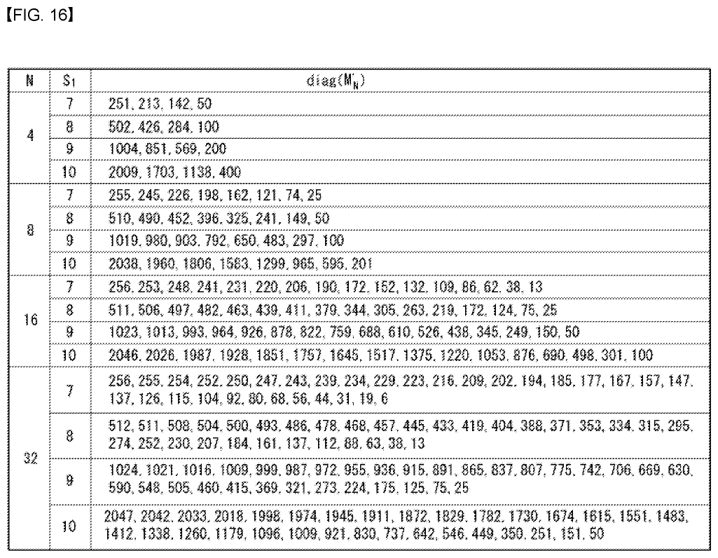

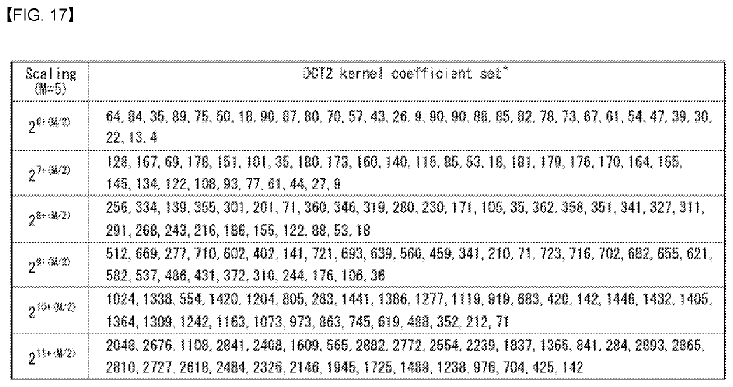

FIGS. 17 and 18 illustrate embodiments to which the present disclosure is applied. FIG. 17 illustrates sets of DCT kernel coefficients applicable to DST4 or DCT4, and FIG. 18 illustrates a forward DCT2 matrix generated from a set of DCT2 kernel coefficients.

According to an embodiment of the present disclosure, DCT2 kernel coefficient which is the same as HEVC may be used. 31 different coefficients of DCT2, which are facilitated by symmetries among all DCT2 kernel coefficients of all sizes up to 32×32, are required to be maintained.

In the case of reusing the existing DCT2 implementation, it is not required to save additional coefficients of DCT2 used in DST4 or DCT4.

In the case of using a specific DCT2 kernel, not the existing DCT2, according to the present disclosure, only a set of DCT2 kernel coefficients which are 31 coefficients using the same kind of symmetry may be added. That is, in the case that up to 2ⁿ×2ⁿ DCT2 are supported, according to the present disclosure, only (2ⁿ−1) different coefficients are required.

Such an additional set may have higher or lower accuracy than the existing set. In the case that a dynamic range of z does not exceed the range supported by the existing DCT2 design, according to the present disclosure, bit lengths of internal variables are not extended, but the same routine of DCT2 may be reused, and the legacy design of DCT2 may be reused.

Even in the case that more arithmetical accuracy of DST4/DCT4 than DCT2 is required, an updated routine available to accumulate higher accuracy is also enough to perform the exiting DCT2. For example, more accurate sets of DCT coefficients are listed in FIG. 17 above according to scaling factors.

Each coefficient in FIG. 17 may be further adjusted to improve orthogonality between basis vectors. A norm of each basis vector may be proximate to 1, and Frobenius norm error may be reduced from floating-point accurate DCT2 kernel.

In the case that a coefficient set is given by (a,b,c,d,e,f,g,h,i,j,k,l,m,n,o,p,q,r,s,t,u,v,w,x,y,z,A,B,C,D,E), the forward DCT2 generated from the coefficient set may be configured as shown in FIG. 18.

In FIG. 18, each DCT2 coefficient set (each row of FIG. 18) is described in a form of (a,b,c,d,e,f,g,h,i,j,k,l,m,n,o,p,q,r,s,t,u,v,w,x,y,z,A,B,C,D,E). This reflects that only 31 possibly different coefficients are required for all DCT2 transforms of a size which is not greater than 32×32.

An output of DCT2 transform needs to be post-processed through matrix A_{N} (or D_{N}A_{N}) of DCT4 (or DST4). Before providing an input vector to matrix A_{N} (or D_{N}A_{N}) of DCT4 (or DST4), a DCT2 output vector as the input vector may be rounded as a value for accuracy adjustment to store variables of a limited bit length. When the DCT2 output vector before scaling and rounding is referred to as y, the rounded value ŷ may be determined from Equation 16 below. Like Equation 15, different forms of scaling and rounding may also be applied to Equation 16.

ŷᵢ=(yᵢ+(1<<(S₃−1)))>>S₃,i=0,1, . . . ,N−1 [Equation 16]

In Equation 16 above, when S₃ is 0, any scaling or rounding is not applied to yᵢ. That is, ŷᵢ=yᵢ.

When a final output vector after A_{N} (or D_{N}A_{N}) is multiplied to ŷ is X, most of multiplications may be substituted by simple addition or subtraction except the first 1/\sqrt{2} multiplication. Herein, 1/\sqrt{2} factor is a constant number, as represented by Equation 17 below, may be approximated as much as a hardwired multiplication by a right shift. Like Equation 15 above, different forms of scaling and rounding may be applied to Equation 17.

X₀=(ŷ₀·F+(1<<(S₄−1)))>>S₄ [Equation 17]

In Equation 17, F and S₄ need to satisfy the condition that F>>S₄ is very approximate to 1/\sqrt{2}. One of methods for obtaining (F, S₄) pair is to use F=round {(1/\sqrt{2})<<S₄}.

According to the present disclosure, for more accurate approximation to 1/\sqrt{2}, S₄ may be increased. However, increase of S₄ requires intermediate variables of longer length, and this may increase implementational complexity. Table 1 below represents available pairs of (F, S₄) approximated to 1/\sqrt{2}.

TABLE 1

| S₄ | F |
|---|---|
| 7 | 91 |
| 8 | 181 |
| 9 | 362 |
| 10 | 724 |
| 11 | 1448 |

In Equation 17, not to change the whole scaling, in the present disclosure, it is assumed that a right shift (S₄) as the same amount of a left shift of F is applied, but this is not necessary. In the case of applying the right shift as much as S₅ (<S₄) instead of S₄, according to the present disclosure, all ŷ need to be scaled up as much as 2^{S}^{₄}^{-s}^{₅}. Considering an expected resultant scaling after DCT4 (or DST4) calculation (S_{T}, herein a positive value means the right shift) and all shifts of the previous equations, according to the present disclosure, Equation 18 having all the scaling bit shift values may be configured.

S_{T}=(S₁−S₂)+S_{C}−S₃+(S₄−S₅)−S_{O} [Equation 18]

In Equation 18, Sc indicates a left shift amount owing to DCT2 integer multiplication, and this may be a non-integer value as shown in FIG. 17. So indicates a right shift amount that calculates a final output X of DCT4 (or DST4). A few parts of Equation 18 may be 0. For example, (S₁-S₂), S₃ or (S₅-S₄) may be 0.

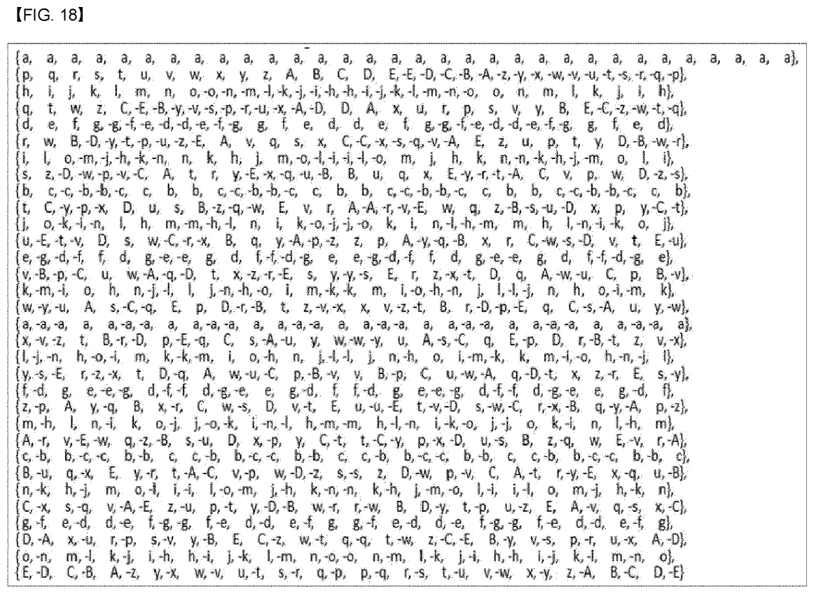

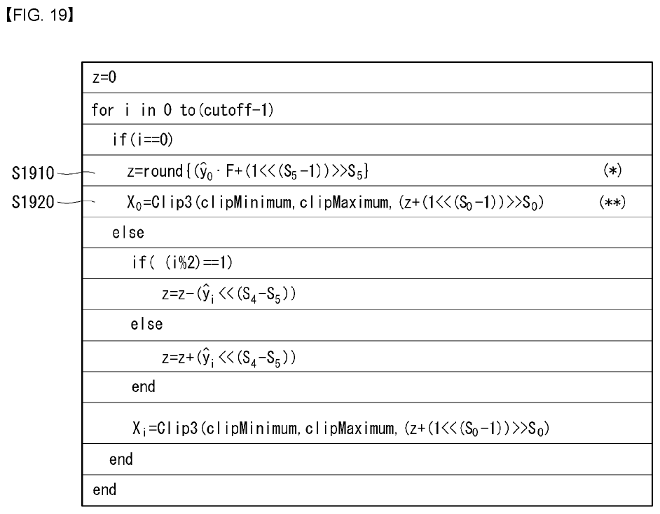

FIGS. 19 and 20 illustrate embodiments to which the present disclosure is applied. FIG. 19 illustrates a code implementation of an output step for DST4, and FIG. 20 illustrates a code implementation of an output step for DCT4.

Assuming that the i^{th} element of a final output vector is Xᵢ, as shown in FIG. 19, an embodiment of the present disclosure may provide an example of code implementation of a final step for DST4 corresponding to a multiplication of (D_{N}A_{N}).

In addition, as shown in FIG. 20, another embodiment of the present disclosure may provide an example of code implementation of a final step for DCT4 corresponding to a multiplication of A_{N}.

cutoff in FIG. 19 shows a valid number of coefficients in vector X. For example, the cutoff may be N.

In FIG. 19, step S1910 and step S1920 may be merged into a single calculation process as represented in Equation 19.

X₀=Clip3(clipMinimum,clipMaximum,(ŷ₀·F+(1<<(S₅+S₀−1))>>(S₅+S_{O})) [Equation 19]

Like Equation 15 above, different forms of scaling and rounding may also be applied to FIG. 19 and Equation 19.

In FIG. 20, step S2010 and step S2020 may be merged into a single calculation process as represented in Equation 20.

X₀=Clip3(clipMinimum,clipMaximum,(ŷ₀·F+(1<<(S₅+S_{O}−1))>>(S₅+S_{O})) [Equation 20]

Like Equation 15 above, different forms of scaling and rounding may also be applied to FIG. 20 and Equation 20.

In FIG. 19 and FIG. 20, Clip3 represents an operation of clipping an argument value to both ends (clipMinimum, clipMaximum).

Each row of A_{N} (or D_{N}A_{N}) may have common pattern with its previous row, and according to the present disclosure, according to a proper sign reversal, a result of the previous row may be reused. Such a pattern may be utilized through variable z, prev in FIG. 19 and FIG. 20. Herein, the variable z, prev reduces a multiplication calculation of A_{N} (or D_{N}A_{N}).

By the variable z, prev, according to the present disclosure, only one multiplication or one addition/subtraction is required for each output. For example, a multiplication may be required only an initial element.

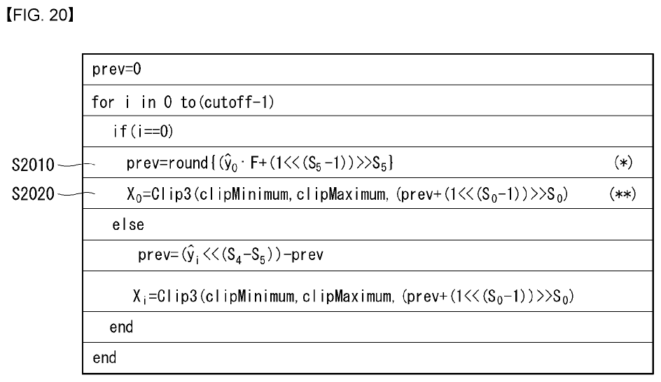

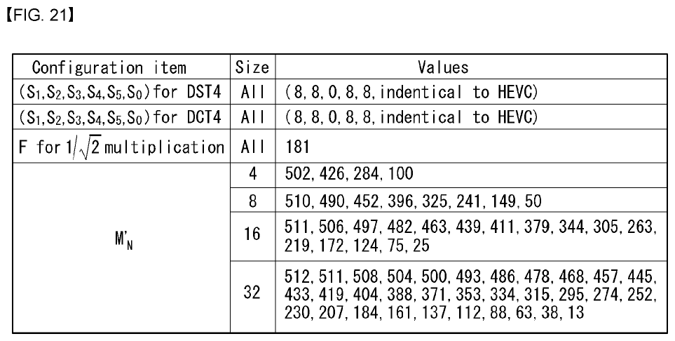

FIG. 21 illustrates a configuration of a parameter set and multiplication coefficients for DST4 and DCT4 when DST4 and DCT4 are performed with forward DCT2 as an embodiment to which the present disclosure is applied.

FIG. 21 shows a configuration of a parameter set and multiplication coefficients for DST4 and DCT4. Each transform of different size may be individually configured. That is, each transform of different size may have respective parameter set and multiplication coefficients.

For example, when a configuration of a parameter set of DST4 is (S₁, S₂, S₃, S₄, S₅, S₀), multiplication coefficient values for all block sizes may be (8, 8, 0, 8, 8, identical to HEVC). Furthermore, when a configuration of a parameter set of DCT4 is (S₁, S₂, S₃, S₄, S₅, S₀), multiplication coefficient values for all block sizes may be (8, 8, 0, 8, 8, identical to HEVC).

In addition, when a configuration of a parameter set is M_{N}′, each block size may have its own multiplication coefficient value shown in FIG. 21.

According to the present disclosure, by Equation 18 above, an implementation of inverse DST4 [DCT4] is the same as forward DST4 [DCT4].

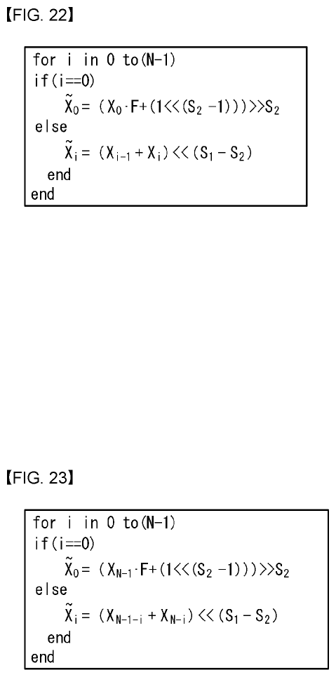

FIGS. 22 and 23 illustrate embodiments to which the present disclosure is applied. FIG. 22 illustrates a code implementation of a pre-processing for DCT4, and

FIG. 23 illustrates a code implementation of a post-processing for DST4.

### Embodiment 3: Alternative Implementation of DST4 and DCT4 with Inverse DCT2

The present disclosure provides a method for implementing DCT4 and DST4 through Equations 10 and 12, respectively.

A_{N}⁻¹, (A_{N}⁻¹J_{N}), M_{N}⁻¹ and (D_{N}M_{M}⁻¹) may be used instead of A_{N}, (D_{N}A_{N}), M_{N} and (M_{N}J_{N}), each of them requires smaller calculation amount in comparison with DCR2. The inverse DCT2 is applied instead of the forward DCT2 in Equations 10 and 12.

In contrast to Equations 8 and 11, A_{N}⁻¹ or (A_{N}⁻¹J_{N}) is applied in an input vector x, and M_{N}⁻¹ or (D_{N}M_{M}⁻¹) is applied in an output vector of DCT2.

As represented in Equations 9 and 12, only one element is multiplied as much as \sqrt{2} in A_{N}⁻¹ and (A_{N}⁻¹J_{N}). In this case, A_{N}⁻¹ and (A_{N}⁻¹J^{N}) may be approximated by an integer multiplication as much as a right shift.

In Equation 10, an example of a code implementation of a pre-processing for DCT4 is as shown in FIG. 22, and this corresponds to a multiplication of A_{N}⁻¹. In addition, in Equation 12, an example of a code implementation of a pre-processing for DCT4 is as shown in FIG. 23, and this corresponds to a multiplication of (A_{N}⁻¹J_{N}).

As represented in Equation 15, other forms of scaling and rounding are also applicable to Tables 8 and 9 below.

In FIGS. 22 and 23, N indicates a length of transform basis vector as well as a length of input vector x. F and S₁ indicate a multiplication factor and right shift amount for approximating \sqrt{2} of the relation x·\sqrt{2}≈(x·F+(1<<(S₁−1)))>>S₁.

In FIGS. 22 and 23, an input vector needs to be scaled up as much as 2^{S1-S2}, S₂ is used for rounding instead of S₁. When S₁ is equal to S₁, scaling is not required to the input vector. Table 2 below represents an example of (F, S₁) pair for approximating \sqrt{2} multiplication.

TABLE 2

| S₁ | F |
|---|---|
| 7 | 181 |
| 8 | 362 |
| 9 | 724 |
| 10 | 1448 |
| 11 | 2896 |

As represented in Equation 16 above, according to the present disclosure, in order to use a variable of shorter bit length, an inverse DCT2 output may be scaled down. When an inverse DCT2 output vector is referred to y, and i^{th} element is referred to yᵢ, a scaled down output vector ŷ may be obtained according to Equation 21 below.

ŷᵢ=(yᵢ+(1<<(S₃−1)))>>S₃,i=0,1, . . . ,N−1 [Equation 21]

In Equations 10 and 12 above, post-processing steps correspond to M_{N}⁻¹ and (D_{N}M_{N}⁻¹), respectively. In this case, the associated diagonal coefficients may be scaled up for a fixed point or integer multiplication. Such a scale up may be performed with proper left shifts as represented in Equation 22 below.

$${[ {M}_{N}^{- {1}^{′}} ]}_{n , k} = \{ \begin{matrix}round \{ [ 1 / 2 cos \frac{π ( 2 n + 1 )}{4 N} ] << {S}_{4} \} , if n = k \\ 0 , otherwise\end{matrix} \\ n , k = 0 , 1 , … , N - {1 \\ [ {( {D}_{N} {M}_{N}^{- 1} )}^{′} ]}_{n , k} = \{ \begin{matrix}round \{ [ {( - 1 )}^{n} / 2 cos \frac{π ( 2 n + 1 )}{4 N} ] << {S}_{4} \} , if n = k \\ 0 , otherwise\end{matrix} \\ n , k = 0 , 1 , … , N - 1 \qquad [ Equation 22 ]$$

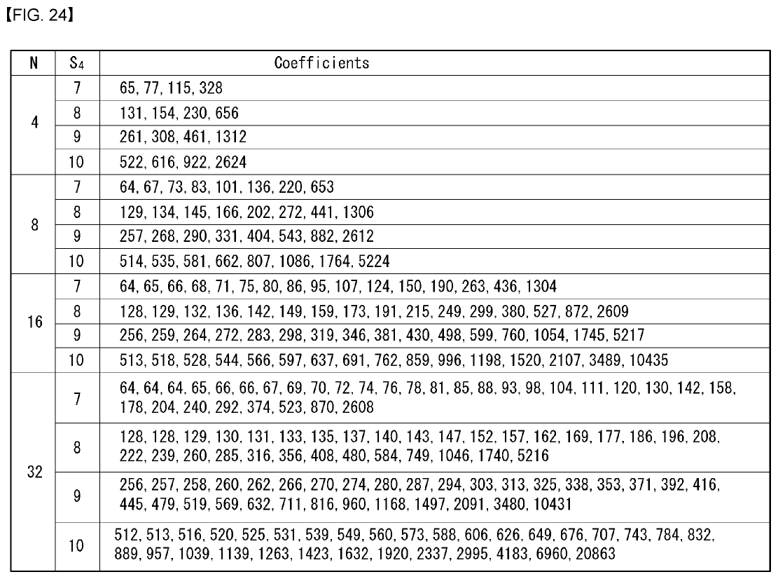

FIG. 24 illustrates diagonal elements for a transform block size N and a right shift amount S₄ pair when DST4 and DCT4 are performed with inverse DCT2 as an embodiment to which the present disclosure is applied.

Examples of diagonal elements of M_{N}^{-1′} may be shown as various combinations of N and S₄ of FIG. 24 above.

As described in embodiment 2 above, S₄ may be differently configured for each transform size. In FIG. 24, in the case that (N, S₄) is (32, 9), great numbers like ‘10431’ may be decomposed to numbers proper to a multiplication of operation part of shorter bit length as represented in Equation 23. This may be applied in the case that a great number of multiplications is shown.

10431·x=(8096+2048+287)·x=(x<<13)+(x<<11)+(287·x) [Equation 23]

Examples corresponding to (D_{N}M_{N}⁻¹)′ may be derived from FIG. 24 above. For example, in the case that (N, S₄) is (4, 9), a vector is [261, −308, 461, −1312].

The non-zero elements may be usable only on diagonal lines in M_{N}^{-1′} and (D_{N}M_{N}⁻¹)′, and the associated matrix multiplication may be performed by simple element-wise multiplication as represented in Equation 24.

$$\hat{X} = \{ \begin{matrix}{[ \begin{matrix}{\hat{y}}_{0} \cdot {[ {M}_{N}^{- {1}^{′}} ]}_{0 , 0} & {\hat{y}}_{1} \cdot {[ {M}_{N}^{- {1}^{′}} ]}_{1 , 1} & … & {\hat{y}}_{N - 1} \cdot {[ {M}_{N}^{- {1}^{′}} ]}_{N - 1 , N - 1}\end{matrix} ]}^{T} for DCT 4 \\ {[ \begin{matrix}{\hat{y}}_{0} \cdot {[ {( {D}_{N} {M}_{N}^{- 1} )}^{′} ]}_{0 , 0} & {\hat{y}}_{1} \cdot {[ {( {D}_{N} {M}_{N}^{- 1} )}^{′} ]}_{1 , 1} & … & {\hat{y}}_{N - 1} \cdot {[ {( {D}_{N} {M}_{N}^{- 1} )}^{′} ]}_{N - 1 , N - 1}\end{matrix} ]}^{T} = \\ {[ \begin{matrix}{\hat{y}}_{0} \cdot {[ {M}_{N}^{- {1}^{′}} ]}_{0 , 0} & - {\hat{y}}_{1} \cdot {[ {M}_{N}^{- {1}^{′}} ]}_{1 , 1} & … & {( - 1 )}^{N - 1} \cdot {\hat{y}}_{N - 1} \cdot {[ {M}_{N}^{- {1}^{′}} ]}_{N - 1 , N - 1}\end{matrix} ]}^{T} for DST 4\end{matrix} \qquad [ Equation 24 ]$$

When a final output vector is referred to as X, \hat{X} calculated from Equation 24 above needs to be scaled properly to satisfy a given expected scaling. For example, in the case that a left shift amount for obtaining the final output vector X is S_{O}, and the expected scaling is S_{T}, the entire relation between shift lengths together with S_{O} and ST may be configured as represented in Equation 25 below.

Xᵢ=(\hat{X}ᵢ+(1<<(S_{O}−1)))>>(S_{O},i=0,1, . . . ,N−1

S_{T}=(S₁−S₂)+S_{C}−S₃+S₄−S_{O} [Equation 25]

Herein, S_{T} may have a non-negative value as well as a negative value. S_{C} may have a value as represented in Equation 18 above. As represented in Equation 15 above, other forms of scaling and rounding may be applicable to Equation 25 above.

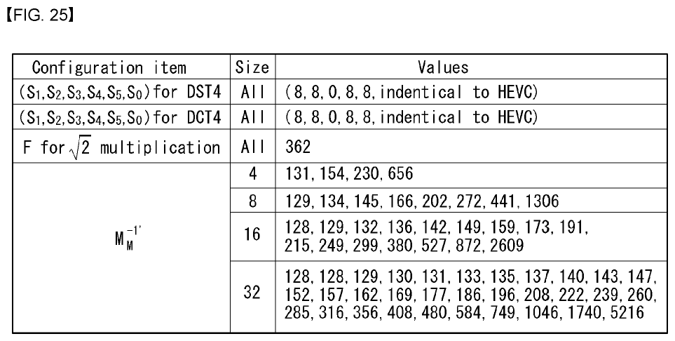

FIG. 25 illustrates a configuration of a parameter set and multiplication coefficients for DST4 and DCT4 when DST4 and DCT4 are performed with inverse DCT2 as an embodiment to which the present disclosure is applied.

FIG. 25 shows a configuration of a parameter set and multiplication coefficients in alternative implementation for DST4 and DCT4. Each transform of different size may be individually configured. That is, each transform of different size may have respective parameter set and multiplication coefficients.

For example, when a configuration of a parameter set of DST4 is (S₁, S₂, S₃, S₄, S₅, S₀), multiplication coefficient values for all block sizes may be (8, 8, 0, 8, 8, identical to HEVC). Furthermore, when a configuration of a parameter set of DCT4 is (S₁, S₂, S₃, S₄, S₅, S₀), multiplication coefficient values for all block sizes may be (8, 8, 0, 8, 8, identical to HEVC).

In addition, when a configuration of a parameter set is M_{N}^{-1′}, each block size may have its own multiplication coefficient value shown in FIG. 25.

According to the present disclosure, by Equation 18 above, an implementation of inverse DST4 [DCT4] is the same as forward DST4 [DCT4].

FIGS. 26 and 27 illustrate embodiments to which the present disclosure is applied. FIG. 26 illustrates an MTS mapping for an intra prediction residual, and FIG. 27 illustrates an MTS mapping for an inter prediction residual.

### Embodiment 4: Possible Multiple Transform Selection (MTS) Mapping with DST4 and DCT4

In one embodiment of the present disclosure, DCT4 and DST4 may be used for generating MTS mapping. For example, DST7 and DCT8 may be substituted by DCT4 and DST4.

In another embodiment, only DCT4 and DST4 may be used for generating MTS. For example, Tables 13 and 14 below illustrate MTS examples for an intra predicted residual and an inter predicted residual, respectively.

In another embodiment of the present disclosure, mapping is also available by different combinations of DST4, DCT4, DCT2, and the like.

In another embodiment, an MTS configuration of substituting DCT4 to DCT2 is available.

In another embodiment, mapping for an inter predicted residual configured with DCT8/DST7 is maintained and substituted only for an intra predicted residual.

In another embodiment, a combination of the embodiments is also available.

FIG. 28 illustrates a content streaming system to which the disclosure is applied.

Referring to FIG. 28, the content streaming system to which the disclosure is applied may basically include an encoding server, a streaming server, a web server, a media storage, a user equipment and a multimedia input device.

The encoding server basically functions to generate a bitstream by compressing content input from multimedia input devices, such as a smartphone, a camera or a camcorder, into digital data, and to transmit the bitstream to the streaming server. For another example, if multimedia input devices, such as a smartphone, a camera or a camcorder, directly generate a bitstream, the encoding server may be omitted.

The bitstream may be generated by an encoding method or bitstream generation method to which the disclosure is applied. The streaming server may temporally store a bitstream in a process of transmitting or receiving the bitstream.

The streaming server transmits multimedia data to the user equipment based on a user request through the web server. The web server plays a role as a medium to notify a user that which service is provided. When a user requests a desired service from the web server, the web server transmits the request to the streaming server. The streaming server transmits multimedia data to the user. In this case, the content streaming system may include a separate control server. In this case, the control server functions to control an instruction/response between the apparatuses within the content streaming system.

The streaming server may receive content from the media storage and/or the encoding server. For example, if content is received from the encoding server, the streaming server may receive the content in real time. In this case, in order to provide smooth streaming service, the streaming server may store a bitstream for a given time.

Examples of the user equipment may include a mobile phone, a smart phone, a laptop computer, a terminal for digital broadcasting, personal digital assistants (PDA), a portable multimedia player (PMP), a navigator, a slate PC, a tablet PC, an ultrabook, a wearable device (e.g., a watch type terminal (smartwatch), a glass type terminal (smart glass), and a head mounted display (HMD)), digital TV, a desktop computer, and a digital signage.

The servers within the content streaming system may operate as distributed servers. In this case, data received from the servers may be distributed and processed.

As described above, the embodiments described in the disclosure may be implemented and performed on a processor, a microprocessor, a controller or a chip. For example, the function units illustrated in the drawings may be implemented and performed on a computer, a processor, a microprocessor, a controller or a chip.

Furthermore, the decoder and the encoder to which the disclosure is applied may be included in a multimedia broadcasting transmission and reception device, a mobile communication terminal, a home cinema video device, a digital cinema video device, a camera for monitoring, a video dialogue device, a real-time communication device such as video communication, a mobile streaming device, a storage medium, a camcorder, a video on-demand (VoD) service provision device, an over the top (OTT) video device, an Internet streaming service provision device, a three-dimensional (3D) video device, a video telephony device, and a medical video device, and may be used to process a video signal or a data signal. For example, the OTT video device may include a game console, a Blu-ray player, Internet access TV, a home theater system, a smartphone, a tablet PC, and a digital video recorder (DVR.

Furthermore, the processing method to which the disclosure is applied may be produced in the form of a program executed by a computer, and may be stored in a computer-readable recording medium. Multimedia data having a data structure according to the disclosure may also be stored in a computer-readable recording medium. The computer-readable recording medium includes all types of storage devices in which computer-readable data is stored. The computer-readable recording medium may include a Blu-ray disk (BD), a universal serial bus (USB), a ROM, a PROM, an EPROM, an EEPROM, a RAM, a CD-ROM, a magnetic tape, a floppy disk, and an optical data storage device, for example. Furthermore, the computer-readable recording medium includes media implemented in the form of carriers (e.g., transmission through the Internet). Furthermore, a bit stream generated using an encoding method may be stored in a computer-readable recording medium or may be transmitted over wired and wireless communication networks.

Furthermore, an embodiment of the disclosure may be implemented as a computer program product using program code. The program code may be performed by a computer according to an embodiment of the disclosure. The program code may be stored on a carrier readable by a computer.

### INDUSTRIAL APPLICABILITY

The aforementioned preferred embodiments of the disclosure have been disclosed for illustrative purposes, and those skilled in the art may improve, change, substitute, or add various other embodiments without departing from the technical spirit and scope of the disclosure disclosed in the attached claims.

1. A method for reconstructing a video signal based on low-complexity transform execution, comprising:
obtaining a transform index of a current block from the video signal, wherein the transform index corresponds to any one of a plurality of transform combinations including a combination of DST4 and/or DCT4;
deriving a transform combination corresponding to the transform index, wherein the transform combination includes a horizontal transform and a vertical transform, and wherein the horizontal transform and the vertical transform correspond to at least one of the DST4 or the DCT4;
performing an inverse transform in a vertical direction with respect to the current block by using the DST4;
performing an inverse transform in a horizontal direction with respect to the current block by using the DCT4; and
reconstructing the video signal by using the current block which the inverse transform is performed.

2. The method of claim 1, wherein the DST4 and/or the DCT4 are/is executed by using a forward DCT2 or an inverse DCT2.

3. The method of claim 2, wherein the DST4 and/or the DCT4 apply/applies post-processing matrix M_{N} and pre-processing A_{N} to the forward DCT2 or the inverse DCT2 (herein,
$${[ {M}_{N}^{- 1} ]}_{n , k} = \{ \begin{matrix}1 / 2 cos \frac{π ( 2 n + 1 )}{4 N} , if n = k \\ 0 , otherwise\end{matrix} n , k = 0 , 1 , … , N - 1 , \\ {[ {A}_{N}^{- 1} ]}_{n , k} = \{ \begin{matrix}\sqrt{2} , n = k = 0 \\ 1 , n = k or k + 1 , \\ 0 , otherwise\end{matrix} \\ n = 1 , 2 , … , N - 1 , k = 0 , 1 , … , N - 1 , \\ herein , N represents a block size ) .$$

4. The method of claim 1, wherein the inverse transform of the DST4 is applied for each column when the vertical transform is the DST4, and wherein the inverse transform of the DCT4 is applied for each row when the horizontal transform is the DCT4.

5. The method of claim 1, wherein the transform combination (horizontal transform, vertical transform) includes (DST4, DST4), (DCT4, DST4), (DST4, DCT4) and (DCT4, DCT4).

6. The method of claim 5, wherein when the current block is an intra predicted residual, the transform combination corresponds to transform indexes 0, 1, 2 and 3.

7. The method of claim 5, wherein when the current block is an inter predicted residual, the transform combination corresponds to transform indexes 3, 2, 1 and 0.

8. An apparatus for reconstructing a video signal based on low-complexity transform execution, comprising:
a parsing unit for obtaining a transform index of a current block from the video signal, wherein the transform index corresponds to any one of a plurality of transform combinations including a combination of DST4 and/or DCT4;
a transform unit for deriving a transform combination corresponding to the transform index, performing an inverse transform in a vertical direction with respect to the current block by using the DST4, and performing an inverse transform in a horizontal direction with respect to the current block by using the DCT4, wherein the transform combination includes a horizontal transform and a vertical transform, and wherein the horizontal transform and the vertical transform correspond to at least one of the DST4 or the DCT4; and
a reconstruction unit for reconstructing the video signal by using the current block which the inverse transform is performed.

9. The apparatus of claim 8, wherein the DST4 and/or the DCT4 are/is executed by using a forward DCT2 or an inverse DCT2.

10. The apparatus of claim 9, wherein the DST4 and/or the DCT4 apply/applies post-processing matrix M_{N} and pre-processing A_{N} to the forward DCT2 or the inverse DCT2 (herein,
$${[ {M}_{N}^{- 1} ]}_{n , k} = \{ \begin{matrix}1 / 2 cos \frac{π ( 2 n + 1 )}{4 N} , if n = k \\ 0 , otherwise\end{matrix} n , k = 0 , 1 , … , N - 1 , \\ {[ {A}_{N}^{- 1} ]}_{n , k} = \{ \begin{matrix}\sqrt{2} , n = k = 0 \\ 1 , n = k or k + 1 , \\ 0 , otherwise\end{matrix} \\ n = 1 , 2 , … , N - 1 , k = 0 , 1 , … , N - 1 , \\ herein , N represents a block size ) .$$

11. The apparatus of claim 10, wherein the inverse transform of the DST4 is applied for each column when the vertical transform is the DST4, and wherein the inverse transform of the DCT4 is applied for each row when the horizontal transform is the DCT4.

12. The apparatus of claim 8, wherein the transform combination (horizontal transform, vertical transform) includes (DST4, DST4), (DCT4, DST4), (DST4, DCT4) and (DCT4, DCT4).

13. The apparatus of claim 12, wherein when the current block is an intra predicted residual, the transform combination corresponds to transform indexes 0, 1, 2 and 3.

14. The apparatus of claim 12, wherein when the current block is an inter predicted residual, the transform combination corresponds to transform indexes 3, 2, 1 and 0.
